(19) United States
(12) Patent Application Publication
(10) Pub. No.: US 2026/0071675 A1
(43) Pub. Date: Mar. 12, 2026

(54) TRANSMISSION AND METHOD FOR SHIFTING GEARS

(71) Applicant: BRP-ROTAX GMBH & CO. KG, Gunskirchen (AT)

(72) Inventor: Robert KINDL, Gunskirchen (AT)

(21) Appl. No.: 19/320,458

(22) Filed: Sep. 5, 2025

Related U.S. Application Data
(60) Provisional application No. 63/691,392, filed on Sep. 6, 2024.

(51) Int. Cl. F16H 63/18; F16H 63/32; F16H 63/34; F16H 63/30

(52) U.S. Cl. CPC F16H 63/18; F16H 63/32; F16H 63/3408; F16H 2063/3096; F16H 2063/321

(57) ABSTRACT

A transmission includes an input shaft, an input gear, a shaft, a drive gear, a dog gear, an output gear, and a shifting assembly. The input gear is connected to the input shaft. The drive gear, the dog gear and the output gear are connected to the shaft. The drive gear drivingly engages the input gear. The dog gear selectively axially translates along the shaft between an engaged dog position in which the dog gear is drivingly engaged with the drive gear, and a disengaged dog position in which the dog gear is disengaged from the drive gear. The shifting assembly, which has drive and neutral configurations, includes a shift drum, a retainer, a retainer biasing member, a shift fork and a shift fork biasing member. In the drive configuration, the retainer is in an extended position, and prevents the shift fork from moving toward a disengaged fork position.

### CROSS-REFERENCE TO RELATED APPLICATION

The present application claims priority to United States Provisional Patent Application No. 63/691,392, filed September 6, 2024 entitled “Transmission and Method for Shifting Gears”, which is incorporated by reference herein in its entirety.

### TECHNICAL FIELD

The present technology relates to transmissions, and methods for shifting gears.

### BACKGROUND

Transmissions in vehicles enable transfer and modulation of torque from motors to driving shafts. Transmissions notably enable an operator to switch between different gear settings, such as a drive, park, neutral, and/or reverse.

In some instances, transmissions can generate a lot of noise due to the engagement between various gears. To overcome this issue, clearances between gears can be minimized. In some instances, gear undercuts can be eliminated.

However, by reducing clearances and/or undercuts, these transmissions can be more prone to accidental disengagement of the gears due to shocks.

Therefore, there is a desire for a transmission that can make less noise, while also limiting likelihood of accidental disengagement between gears.

### SUMMARY

It is an object of the present technology to ameliorate at least some of the inconveniences present in the prior art.

According to one aspect of the present technology, there is provided a transmission including: an input shaft, an input gear, a shaft, a drive gear, a dog gear, and a shifting assembly. The input shaft is configured to operatively connect to a motor. The input gear is connected to the input shaft, and is drivingly engaged to the input shaft. The drive gear is connected to the shaft, selectively rotates relative to the shaft, and drivingly engages the input gear. The dog gear is connected to the shaft, drivingly engages the shaft, and the selectively axially translates along the shaft between an engaged dog position and a disengaged dog position. In the engaged dog position, the dog gear is drivingly engaged with the drive gear such that the dog gear rotates together with the drive gear. In the disengaged dog position, the dog gear is disengaged from the drive gear. The output gear is connected to the shaft and drivingly engages the shaft. The shifting assembly includes a shift drum, a retainer, a retainer biasing member, a shift fork, and a shift fork biasing member. The shift drum selectively rotates about a shift drum axis between a first drum position and a second drum position. The retainer is connected to the shift drum, and selectively moves between a retracted position and an extended position. The retainer biasing member biases the retainer toward the extended position. The shift fork engages the shift drum and is operatively connected to the dog gear. The shift fork selectively moves between an engaged fork position and a disengaged fork position. With the shift fork in the engaged fork position, the shift drum is in the first drum position. With the shift fork in the disengaged fork position, the shift drum is in the second drum position. The shift fork biasing member biases the shift fork toward the engaged fork position. The shifting assembly has a driving configuration and a neutral configuration. In the drive configuration, the shift drum is in the first drum position, the shift fork is in the engaged fork position, such that the dog gear is in the engaged dog position, and the retainer is in the extended position, and prevents the shift fork from moving toward the disengaged fork position. In the neutral configuration, the shift drum is in the second drum position, the shift fork is in the disengaged fork position, such that the dog gear is in the disengaged dog position, and the retainer permits the shift fork to move between the disengaged fork position and the engaged fork position. In response to the shift drum rotating from the second drum position toward the first drum position, the shift fork moves from the disengaged fork position toward the engaged fork position, and the shift fork causes the dog gear to move toward the engaged dog position.

In some embodiments, in response to the shift drum rotating from the second drum position toward the first drum position, and the shift fork being in an intermediate fork position, the intermediate fork position being between the engaged fork position and the disengaged fork position, the retainer abuts the shift fork and the shift fork causes the retainer to move toward the retracted position.

In some embodiments, the shift fork has an abutting arm configured to abut against the retainer.

In some embodiments, with the shift fork being in the disengaged fork position, the abutting arm is spaced from the retainer, with the shift fork being in the engaged fork position and the retainer being in the extended position, the abutting arm is configured to abut the retainer for preventing the shift fork from moving toward the disengaged fork position, and with the shift fork being in the intermediate fork position, part of the abutting arm is configured to abut against the retainer, and cause the retainer to move toward the retracted position.

In some embodiments, the shift drum has a radial surface, and the shift drum defines a guiding groove on the radial surface, the guiding groove extending along at least part of a circumference of the shift drum, and the shift fork has a guiding pin received in the guiding groove.

In some embodiments, the guiding groove has a first groove section and a second groove section, the second groove section being axially narrower than the first groove section, and with the shift drum in the second drum position, the guiding pin is in the second groove section.

In some embodiments, the shift drum has a stopper stopping the retainer at the extended position.

In some embodiments, the retainer defines a recess configured to receive the stopper therein.

In some embodiments, the shaft is a countershaft, the output gear is an intermediate output gear, and the transmission further includes an output shaft, and an output gear connected to the output shaft, and the output gear being driven by the intermediate output gear.

In some embodiments, the retainer is pivotally connected to the shift drum.

In some embodiments, the retainer is a lever.

In some embodiments, the transmission further includes a park gear and a parking lever. The park gear is connected to the shaft, and the park gear is drivingly engaged to the shaft. The parking lever is selectively moveable between a parked position in which the parking lever is engaged with the park gear such that rotation of the park gear is prevented, and a move position in which the parking lever is disengaged from the park gear. The shifting assembly also has a park configuration in which the parking lever is in the parked position.

In some embodiments, the park gear and the dog gear are integral.

In some embodiments, the shift drum is further rotatable about the shift drum axis to a third shift drum position, the second shift drum position being intermediate to the first shift drum position and the third shift drum position, and with the shifting assembly being in the park configuration, the shift drum is in the third shift drum position.

In some embodiments, the transmission further includes a parking cam operatively connected to the shift drum, the parking cam being rotatable between a first cam position, and a second cam position, in which the parking cam causes the parking lever to be in the parked position.

In some embodiments, the transmission further includes a biasing member biasing the parking cam toward the second cam position.

In some embodiments, the shift drum has an axial surface, and the shift drum defines a side groove on the axial surface, the side groove having a third groove section and a fourth groove section, the fourth groove section being radially wider than the third groove section. The parking lever has a parking pin received in the side groove. With the parking pin being in the third groove section, the parking lever is in the move position. With the parking pin being in the fourth groove section, the parking lever is moveable to the park position.

In some embodiments, the transmission further includes a shift motor operatively connected to the shift drum for moving the shift drum between the first shift drum position and the second shift drum position.

According to another aspect of the present technology, there is provided a method for shifting gears. The method includes rotating a shift drum about a shift drum axis from a first shift drum position to a second shift drum position. The method further includes, in response to the shift drum rotating from the first shift drum position to the second shift drum position, moving a shift fork to a disengaged fork position, and movement of the shift fork to the disengaged fork position causing a dog gear to move to a disengaged dog position. The method further includes rotating the shift drum about the shift drum axis from the second shift drum position to the first shift drum position. The method further includes, in response to the shift drum rotating from the second shift drum position to the first shift drum position, moving the shift fork toward an engaged fork position, and movement of the shift fork toward the engaged fork position causing the dog gear to move toward an engaged dog position. The method further includes moving a retainer together with the shift drum, and in response to the shift fork reaching the engaged fork position, preventing, by the retainer, the shift fork from moving back toward the disengaged fork position.

In some embodiments, in response to rotating the shift drum from the second drum position toward the first drum position, and the shift fork being in an intermediate fork position, the intermediate fork position being between the engaged fork position and the disengaged fork position, the retainer abuts the shift fork and the shift fork causes the retainer to move toward a retracted position.

For purposes of this application, terms related to spatial orientation such as forwardly, rearward, upwardly, downwardly, left, and right, are as they would normally be understood by a driver of the vehicle sitting thereon in a normal riding position. Terms related to spatial orientation when describing or referring to components or sub-assemblies of the vehicle, separately from the vehicle should be understood as they would be understood when these components or sub-assemblies are mounted to the vehicle, unless specified otherwise in this application.

As used herein, the term “about” in the context of a given value or range refers to a value or range that is within 20%, preferably within 10%, and more preferably within 5% of the given value or range.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description and the accompanying drawings.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a left side elevation view of a vehicle;

FIG. 2 is a perspective view taken from a front, top, left side of a transmission of the vehicle of FIG. 1;

FIG. 3 is a perspective view taken from a front, top, right side of the transmission of FIG. 2;

FIG. 4 is a left side elevation view of the transmission of FIG. 2;

FIG. 5 is a cross-sectional view part of the transmission of FIG. 2 taken along line 5-5 of FIG. 4;

FIG. 6 is a perspective view taken from a top, rear, right side of a shifting assembly of the transmission of FIG. 2, the shifting assembly being in a park configuration;

FIG. 7 is a perspective view taken from a top, rear, right side of the shifting assembly of FIG. 6, with the shifting assembly being in a drive configuration;

FIG. 8 is a perspective view taken from a top, rear, right side of the shifting assembly of FIG. 6, with the shifting assembly being between the drive configuration and a neutral configuration;

FIG. 9 is a perspective view taken from a top, rear, right side of the shifting assembly of FIG. 6, with the shifting assembly being in the neutral configuration;

FIG. 10 is a left side elevation view of the shifting assembly of FIG. 6;

FIG. 11 is a left side elevation view of the shifting assembly of FIG. 7;

FIG. 12 is a left side elevation view of the shifting assembly of FIG. 8;

FIG. 13 is a left side elevation view of the shifting assembly of FIG. 9;

FIG. 14 is a perspective view taken from a top, rear, left side of the shifting assembly of FIG. 6, with a shift fork being in an intermediate position, and a retainer being in a retracted position;

FIG. 15 is a left side elevation view of the shifting assembly of FIG. 14;

FIG. 16 is a perspective view taken from a top, front, left side of the shifting assembly of FIG. 7;

FIG. 17 is an exploded perspective view of part of the shifting assembly of FIG. 6;

FIG. 18 is a cross-sectional view of part of the shifting assembly of FIG. 6, taken along the line 18-18 of FIG. 5, with the parking lever being in a park position;

FIG. 19 is a cross-sectional view of part of the shifting assembly of FIG. 6, taken along the line 18-18 of FIG. 5, with the parking lever being in a move position;

FIG. 20 is a perspective view taken from a top, rear, left side of a shifting assembly of a transmission according to an alternative embodiment of the present technology, the shifting assembly being in a neutral configuration;

FIG. 21 is a rear elevation view of part of the shifting assembly of FIG. 20;

FIG. 22 is a rear elevation view of part of the shifting assembly of FIG. 20, with the shifting assembly being in a low-gear configuration;

FIG. 23 is a rear elevation view of part of the shifting assembly of FIG. 20, with the shifting assembly being in a high-gear configuration;

FIG. 24 is a rear elevation view of a shift drum of the shifting assembly of FIG. 20, with retainers and retainer biasing members being shown in solid lines, and the shift drum being shown in dotted lines; and

FIG. 25 is a cross-sectional view of part of the shifting assembly of FIG. 20 taken along a plane passing through one of the retainers, and with the shift rod being laterally aligned with the one of the retainers.

It should be noted that the Figures are not necessarily drawn to scale.

### DETAILED DESCRIPTION

The present technology is described with reference to an off-road side-by-side vehicle. It is contemplated that the present technology could be implemented in different vehicles, including but not limited to all-terrain vehicles, automobiles, other off-road vehicles, snowmobiles, and karts.

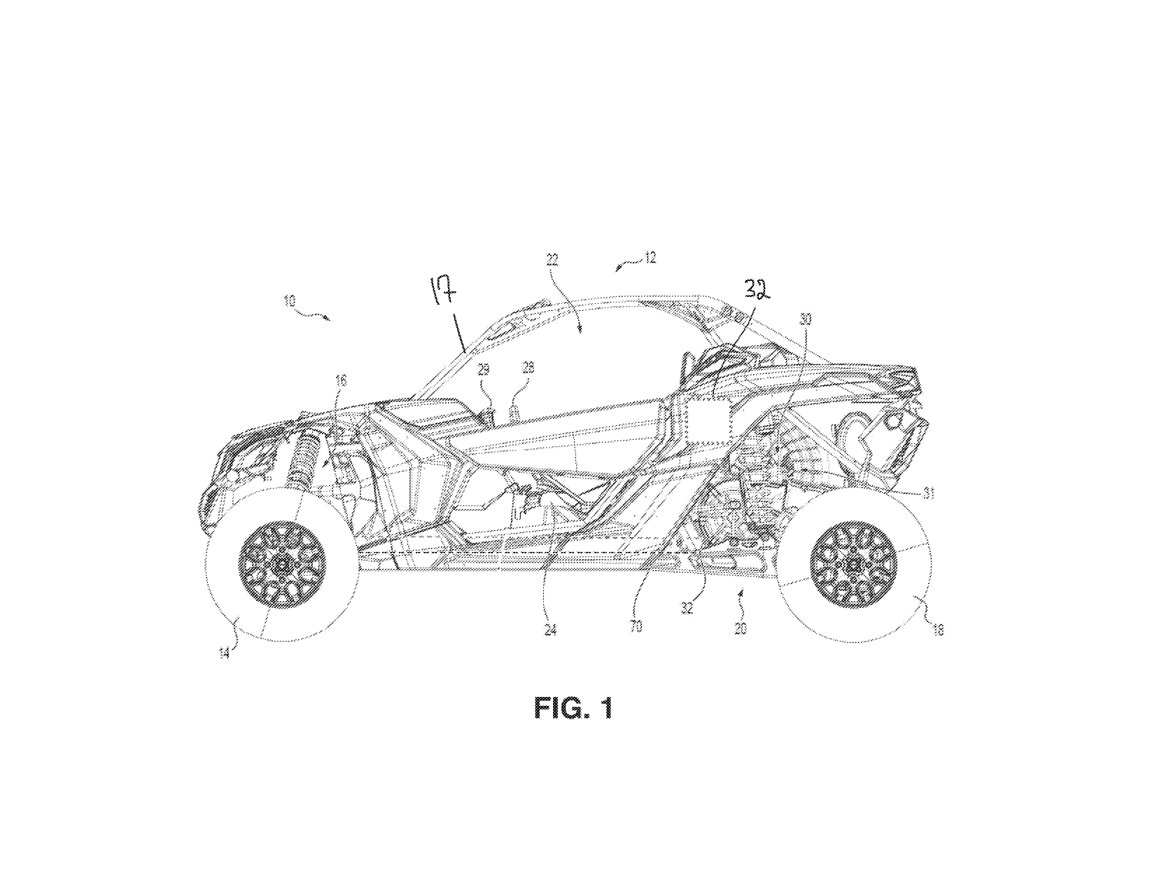

Referring to FIG. 1, a non-limiting embodiment of a side-by-side vehicle 10 is shown. The vehicle 10 has a frame 12, two front wheels 14 connected to a front of the frame 12 by front suspension assemblies 16 and two rear wheels 18 connected to the frame 12 by rear suspension assemblies 20.

The frame 12 defines a central cockpit area 22 inside which are disposed a driver seat 24 and a passenger seat (not shown). A roll cage 17 defines a top side of the cockpit area 22. In the present embodiment, the driver seat 24 is disposed on the left side of the vehicle 10 and the passenger seat is disposed on the right side of the vehicle 10. However, it is contemplated that the driver seat 24 could be disposed on the right side of the vehicle 10 and that the passenger seat could be disposed on the left side of the vehicle 10.

A steering wheel 28 is disposed in front of the driver seat 24. The steering wheel 28 is used to turn the front wheels 14 to steer the vehicle 10. Various displays and gauges 29 are disposed above the steering wheel 28 to provide information to the driver regarding the operating conditions of the vehicle 10. Examples of displays and gauges 29 include, but are not limited to, a speedometer, a tachometer, and a transmission position display.

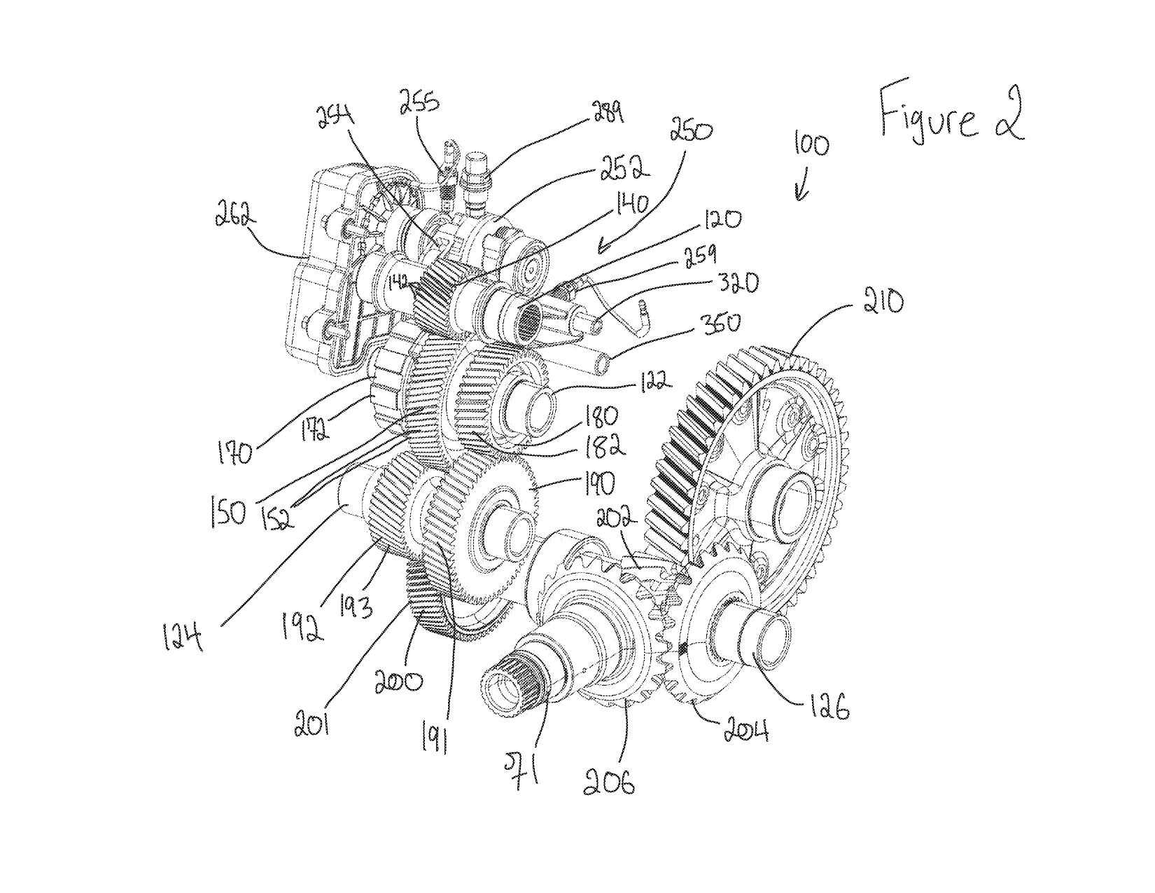

The vehicle 10 further includes a motor assembly 31, which includes an electric motor 30 (hereinafter a motor 30), a transmission 100 (shown in FIG. 2) connected to and driven by the motor 30 and a motor controller 32 (schematically illustrated in FIG. 1) in communication with the motor assembly 31. The motor assembly 31 is connected to the frame 12 at a rear portion of the vehicle 10. The transmission 100 will be described in more detail below. The vehicle 10 also includes batteries (not shown) for powering the motor 30.

The motor 30 is operatively connected to a driveshaft 70 (schematically illustrated in FIG. 1) and to a rear differential gear 210 via the transmission 100 to transmit torque from the motor 30. To propel the vehicle 10, the driveshaft 70 is operatively connected to front wheels 14, and the rear differential gear 210 is operatively connected to the rear wheels 18.

Referring to FIGS. 2 to 5, the transmission 100 will now be described in greater detail. The transmission 100 controls the transfer of torque from the motor 30 to the wheels 14, 18. According to the present technology, a shifting assembly 250 of the transmission 100 can be selectively arranged between a park configuration, a drive configuration and a neutral configuration. The configuration of the shifting assembly 250 may be controlled by an operator of the vehicle 10 moving a gear shift lever (not shown).

In the park configuration, no driving torque is transferred from the motor 30 to the driveshaft 70 and to the rear differential gear 210, and motion of the driveshaft 70 is impeded.

In the drive configuration, driving torque can be transferred from the motor 30 to the driveshaft 70 and to the rear differential gear 210 which causes rotation of the driveshaft 70 and/or of the rear differential gear 210.

In the neutral configuration, no driving torque is transferred from the motor 30 to the driveshaft 70, but motion of the driveshaft 70 is not impeded.

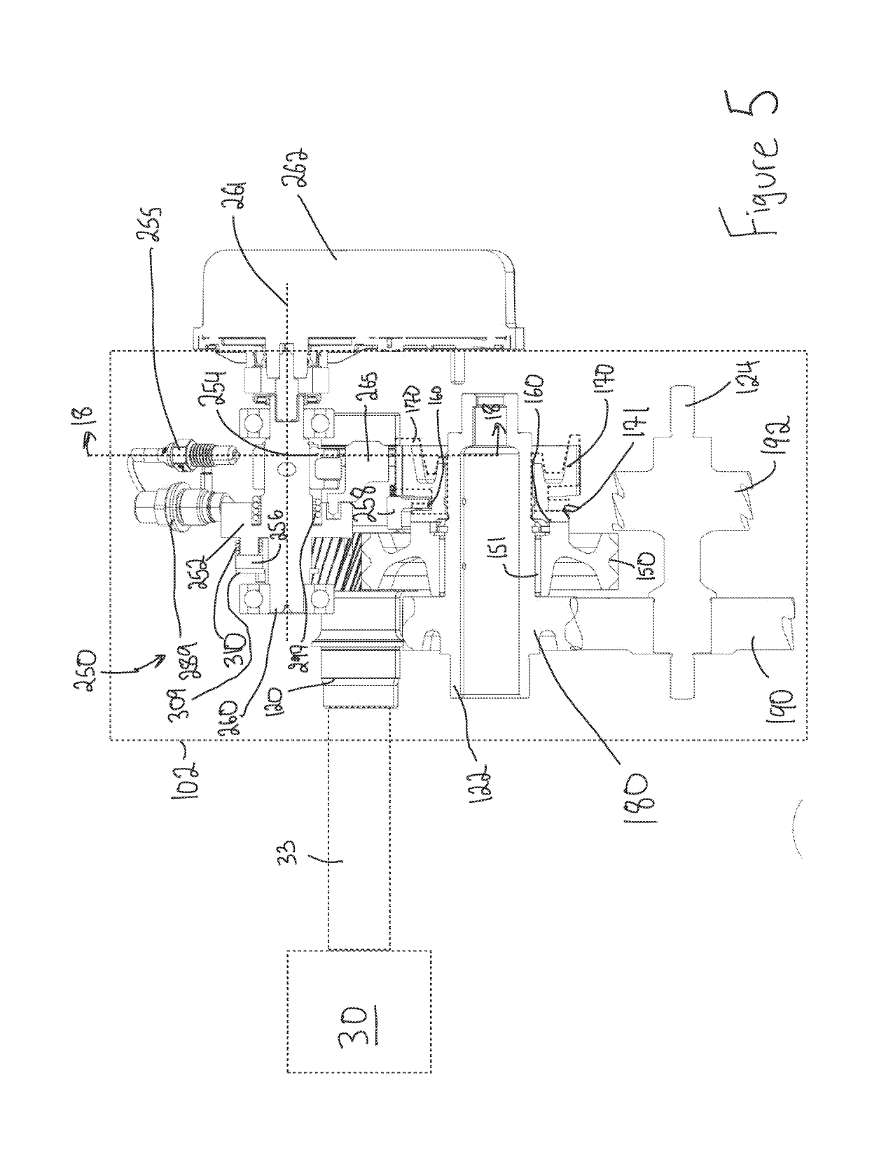

The transmission 100 includes a transmission housing 102 (schematically illustrated in FIG. 5) in which components of the transmission 100 are received. The transmission 100 includes an input shaft 120, a countershaft 122, an intermediate shaft 124 and an output shaft 126. It is contemplated that in some embodiments, the transmission 100 could include additional or fewer shafts. For example, in some embodiments, the intermediate shaft 124 may be omitted. In the present embodiment, the input shaft 120, the countershaft 122, the intermediate shaft 124 and the output shaft 126 extend generally parallel to one another, but it is contemplated that in other embodiments, one or more of the shafts could be oriented differently. For example, one or more of the shafts could be perpendicular to an other one of the shafts.

As schematically illustrated in FIG. 5, the input shaft 120 is operatively connected to an output shaft 33 of the motor 30, such that the motor 30 is selectively operated for causing rotation of the input shaft 120. The direction of rotation of the input shaft 120 may be in either a forward direction or a rearward direction depending on a direction of rotation of the output shaft 33 of the motor 30.

An input gear 140 is connected to the input shaft 120. The input gear 140 is drivingly engaged to the input shaft 120 such that in response to the input shaft 120 rotating, the input gear 140 rotates together with the input shaft 120. In some embodiments, the input gear 140 may be integral with the input shaft 120. In other embodiments, the input gear 140 may be rotationally fixedly connected to the input shaft 120 differently, such as via splines for example. The input gear 140 has radial teeth 142.

The countershaft 122 is disposed vertically lower than and longitudinally rearward of the input shaft 120. It is contemplated that the countershaft 122 may be positioned differently. A drive gear 150, a dog gear 160, a park gear 170 and an intermediate gear 180 are connected to the countershaft 122.

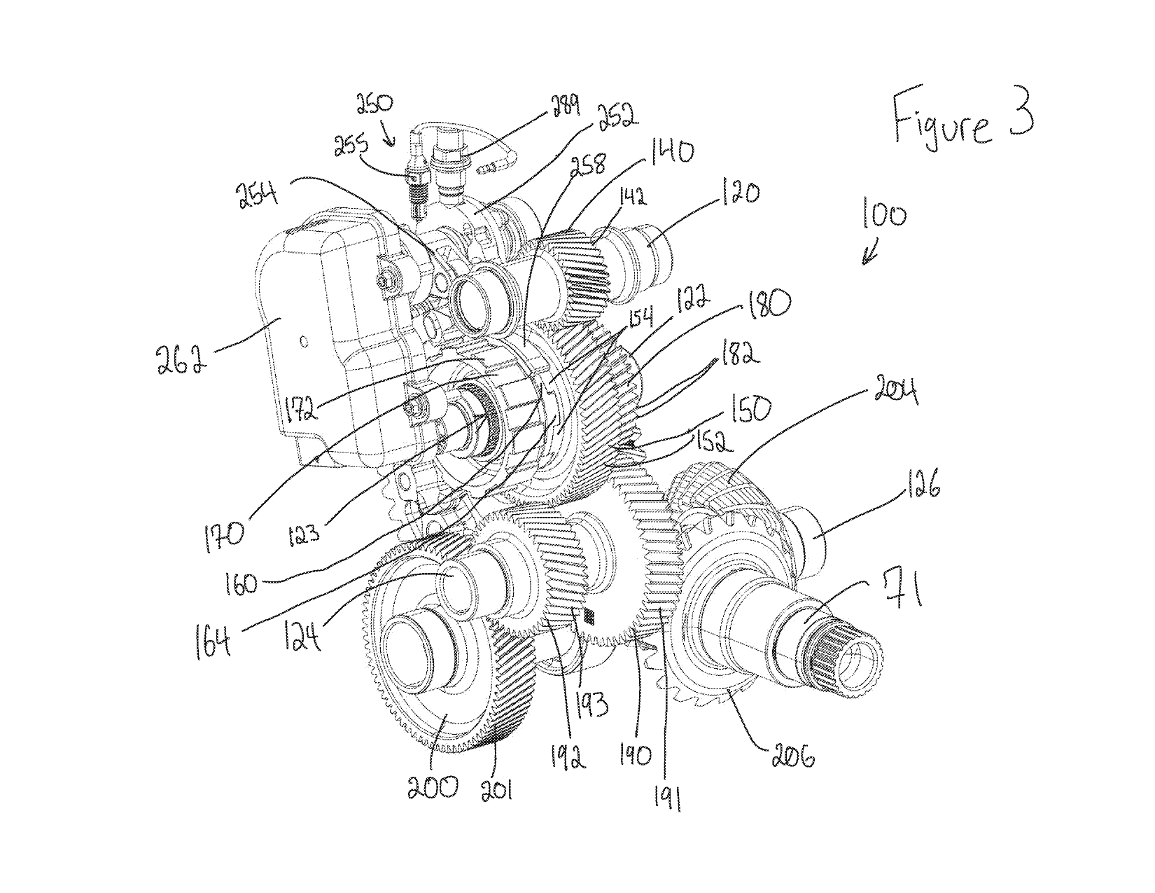

The drive gear 150 is rotationally connected to the countershaft 122 via a bearing 151 (FIG. 5). It is contemplated that the drive gear 150 may be connected to the countershaft 122 differently. As will be described below, the drive gear 150 is selectively rotationally fixed to the countershaft 122 via the dog gear 160. The drive gear 150 has radial teeth 152 and axial teeth 154 (FIG. 3). The drive gear 150 is drivingly engaged to the input gear 140, such that the radial teeth 152 of the drive gear 150 are in engagement with the radial teeth 142 of the input gear 140.

The dog gear 160 and the park gear 170 are unitary. It is contemplated, however, that in some embodiments, the dog gear 160 and the park gear 170 could be separate from one another. A recess 171 is defined between the dog gear 160 and the park gear 170. As will be described below, the recess 171 is configured to receive part of a shift fork 258 of the transmission 100 therein.

The dog gear 160 is drivingly engaged to the countershaft 122 via splines 123 (FIG. 3). The splines 123 fixedly rotationally connect the dog gear 160 to the countershaft 122 while also permitting axial movement of the dog gear 160 between an engaged dog position (FIGS. 2 to 5) and a disengaged dog position (illustrated by dotted lines in FIG. 5). The dog gear 160 has axial teeth 164 (FIG. 3) that are configured to engage with the axial teeth 154 of the drive gear 150. More specifically, when the dog gear 160 is in the engaged dog position, the axial teeth 164 of the dog gear 160 are in engagement with the axial teeth 154 of the dog gear 160, such that when the drive gear 150 rotates, the dog gear 160 rotates with the drive gear 150, which in turn causes the countershaft 122 to rotate. When the dog gear 160 is in the disengaged dog position, the axial teeth 164 are not drivingly engaged with the axial teeth 154, such that the drive gear 150 can rotate relative to the countershaft 122.

Being that the park gear 170 is integral with the dog gear 160, when the dog gear 160 moves axially along the countershaft 122, the park gear 170 also moves. Additionally, the park gear 170 is also drivingly engaged to the countershaft 122. The park gear 170 has radial teeth 172.

The intermediate gear 180, which may be referred to as intermediate output gear, is integral with the countershaft 122, such that in response to the countershaft 122 rotating, the intermediate gear 180 rotates with the countershaft 122. It is contemplated that in other embodiments, the intermediate gear 180 could be fixedly rotationally connected to the countershaft 122 differently. The intermediate gear 180 has radial teeth 182.

The intermediate shaft 124 is disposed vertically lower than and longitudinally forward of the countershaft 122. It is contemplated that the intermediate shaft 124 may be positioned differently. Gears 190, 192 are connected to the intermediate shaft 124.

The gears 190, 192 are both fixedly rotationally connected to the intermediate shaft 124. The gear 190 has radial teeth 191 and the gear 192 has radial teeth 193. The gear 190 is larger than the gear 192. It is contemplated that the transmission 100 could be configured such that the gear 190 is smaller than the gear 192. The gear 190 is drivingly engaged to the intermediate gear 180, such that the radial teeth 191 of the gear 190 are in engagement with the radial teeth 182 of the intermediate gear 180.

The output shaft 126 is disposed vertically lower than and longitudinally rearward of the intermediate shaft 124. It is contemplated that the output shaft 126 may be positioned differently. An output gear 200, a pinion 202 and a bevel gear 204 are connected to the output shaft 126.

The output gear 200 is fixedly rotationally connected to the output shaft 126, such that in response to the output gear 200 rotating, the output shaft 126 also rotates. The output gear 200 has radial teeth 201. The output gear 200 is engaged to the gear 192 such that the radial teeth 201 of the output gear 200 are in engagement with the radial teeth 193 of the gear 192. Thus, the transmission 100 is configured such that the output gear 200 can be driven by the input gear 140.

The pinion 202 is also fixedly rotationally connected to the output shaft 126, such that in response to the output shaft 126 rotating, the pinion 202 also rotates. The pinion 202 is drivingly engaged to the rear differential gear 210.

The bevel gear 204 is also fixedly rotationally connected to the output shaft 126, such that in response to the output shaft 126 rotating, the bevel gear 204 also rotates. The bevel gear 204 is further drivingly connected to a bevel gear 206 that is fixedly rotationally connected to a shaft 71 that drivingly connects to the driveshaft 70.

It is contemplated that in some embodiments, the intermediate gear 180 could be the output gear of the transmission 100, such that the intermediate shaft 124, the gears 190, 192, the output shaft 126 and the output gear 200 could be omitted. In such embodiments, the countershaft 122 would be an output shaft.

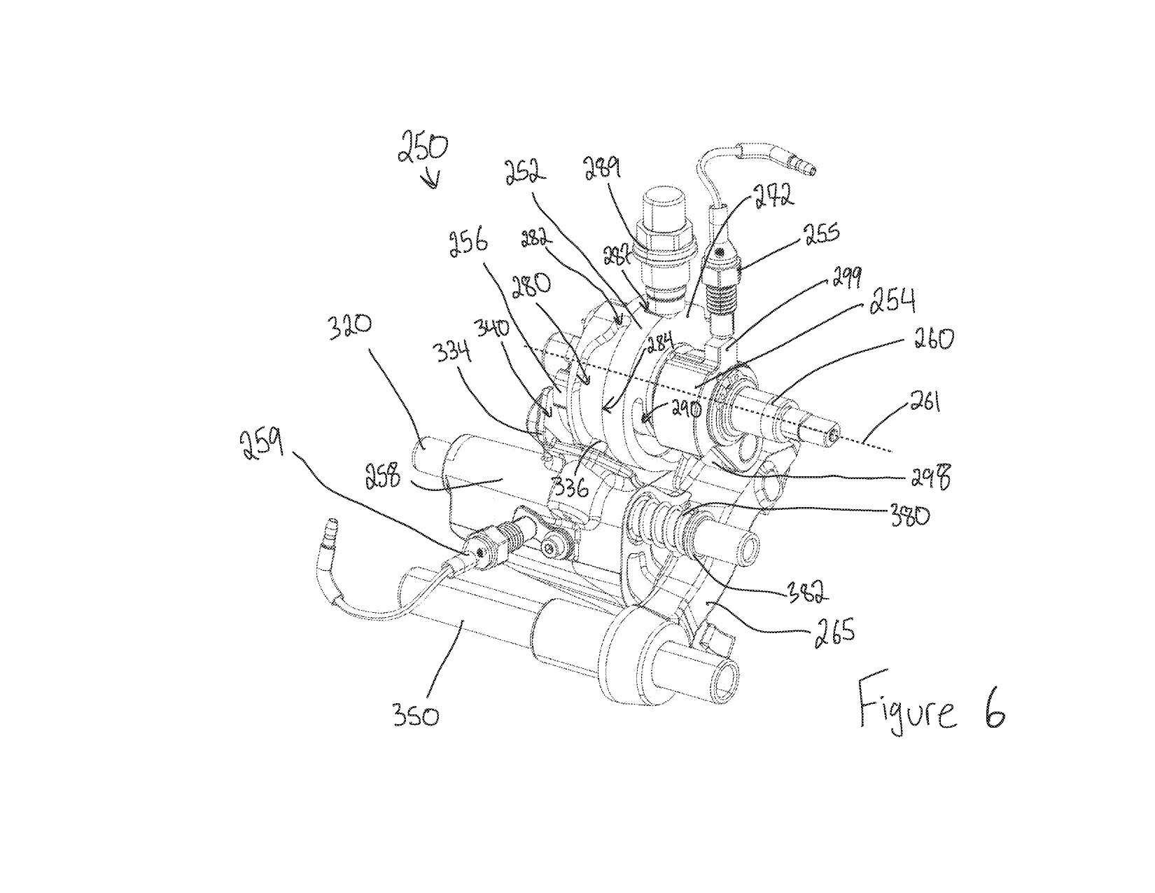

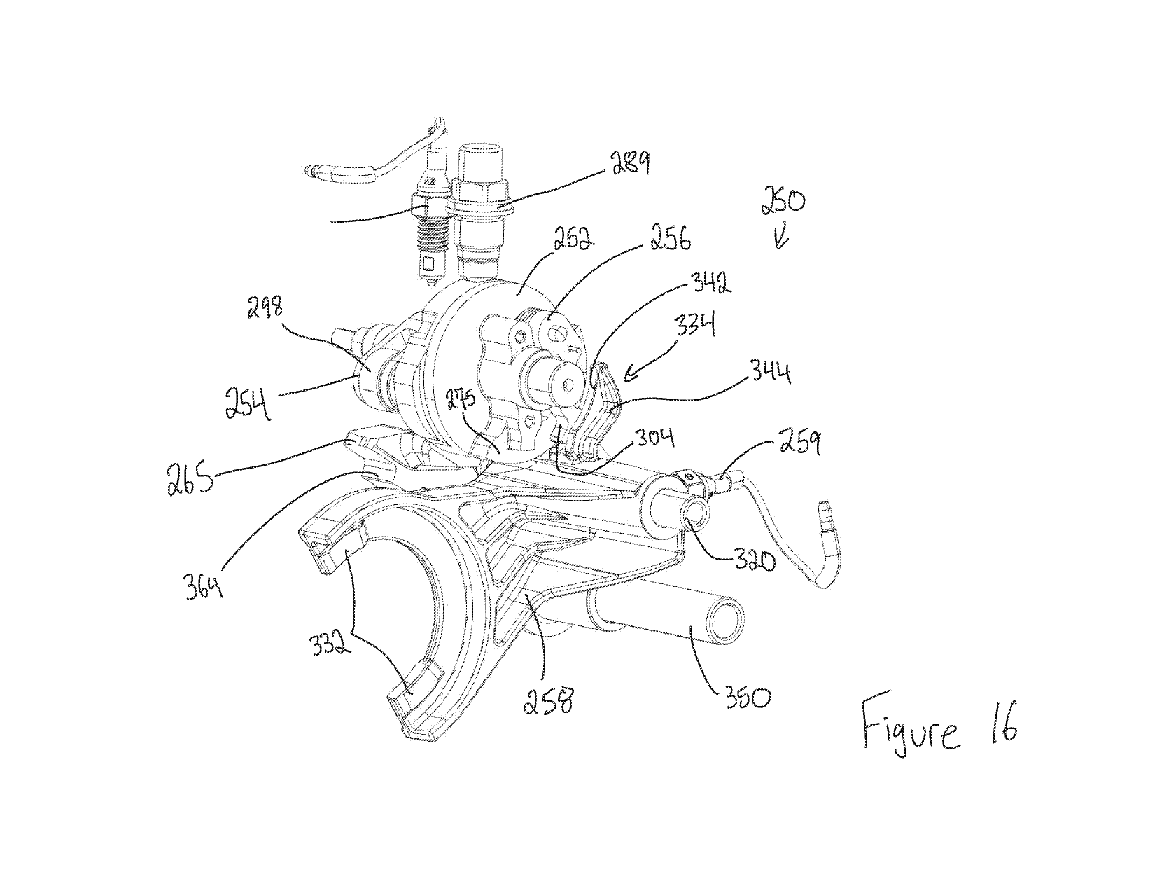

The shifting assembly 250 will now be described with reference to FIGS. 6 to 19. The shifting assembly 250 includes a shift drum 252. The shifting assembly 250 also includes a parking cam 254 and a retainer 256, both of which are connected to the shift drum 252. The shifting assembly 250 further includes a shift fork 258 and a parking lever 265. As will be described in greater detail below, the shifting assembly 250 can be configured between the parked, drive and neutral configurations.

A shift drum shaft 260 extends generally parallel to the input shaft 120. The shift drum shaft 260 is positioned rearwardly of the input shaft 120. It is contemplated that the shift drum shaft 260 could be positioned elsewhere.

The shift drum shaft 260 is operatively connected to a shift motor 262 of the transmission 100. The shift motor 262 is disposed outside of the transmission housing 102, as shown in FIG. 5. The shift drum shaft 260 defines a shift drum axis 261. The shift drum shaft 260 is rotatable about the shift drum axis 261 in response to the shift motor 262 being operated. It is contemplated that the shift drum shaft 260 could be rotated via a foot shift lever instead of the shift motor 262.

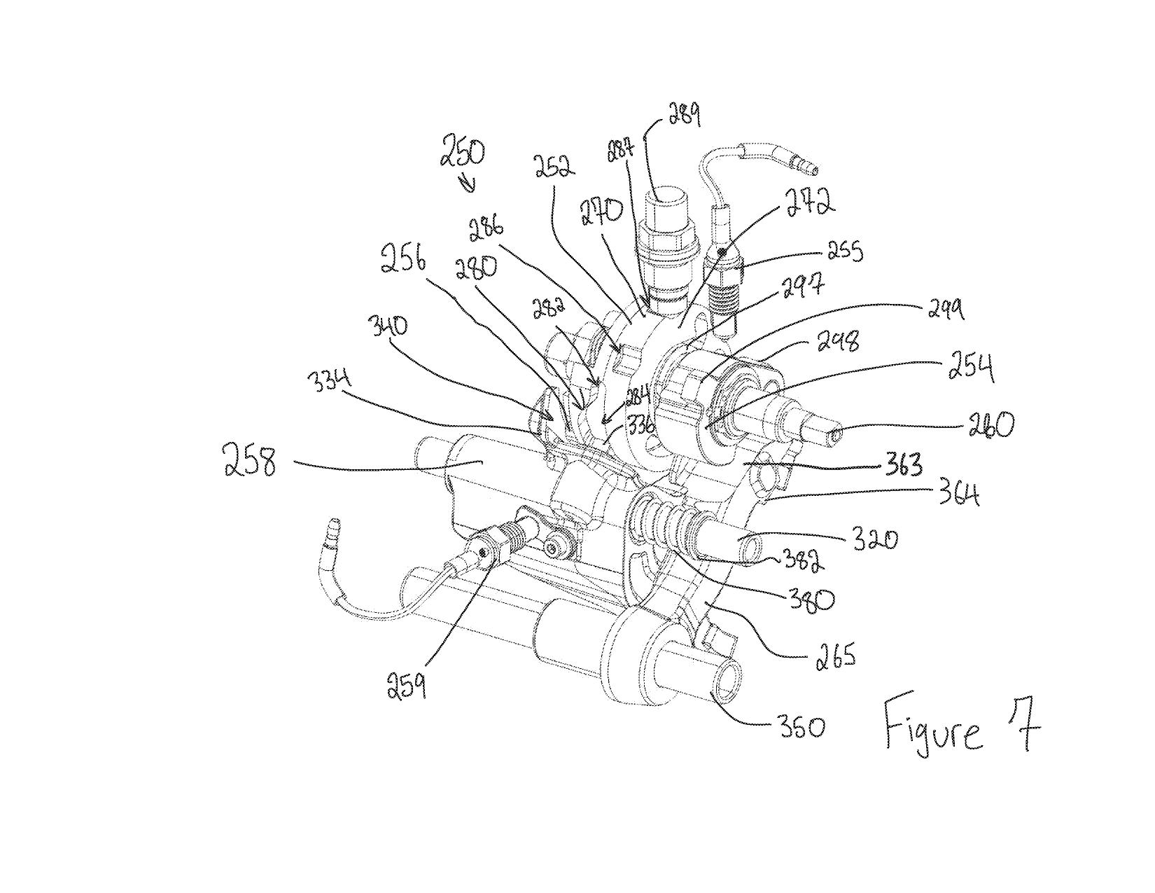

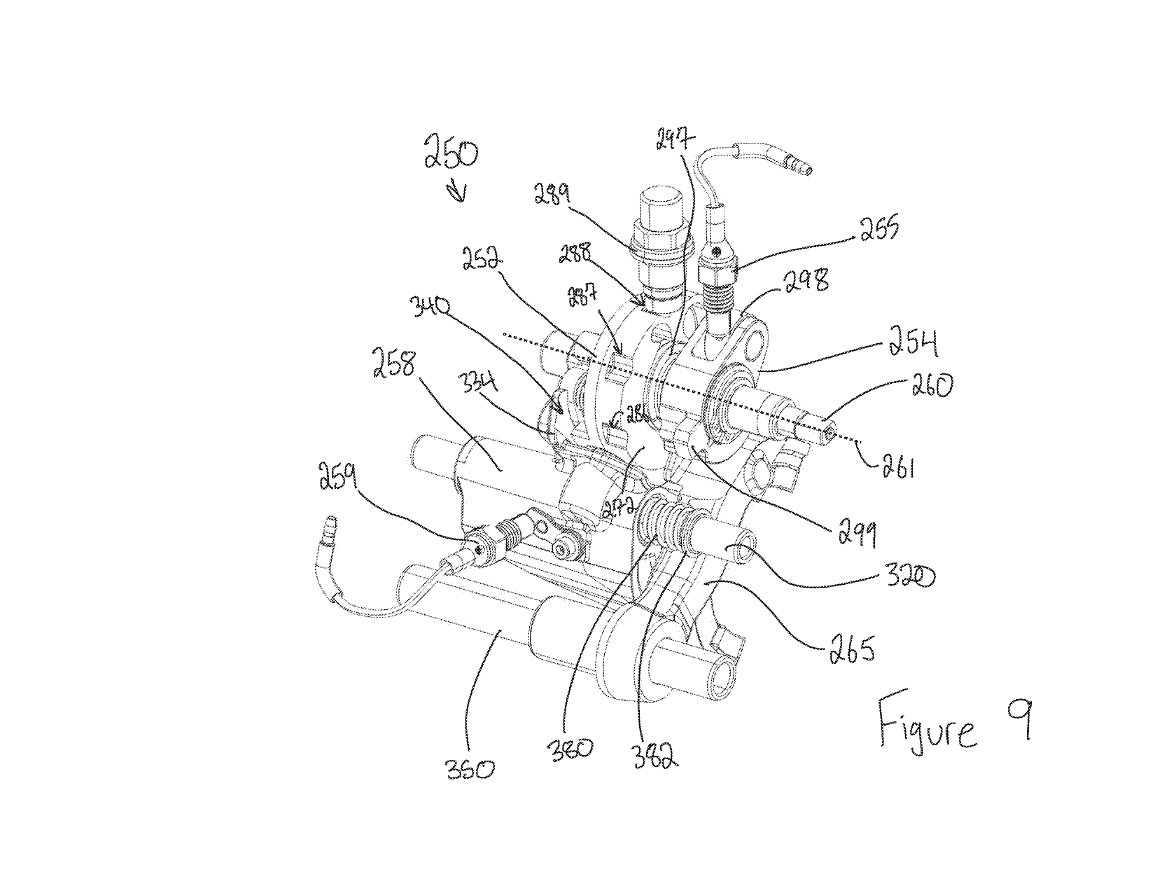

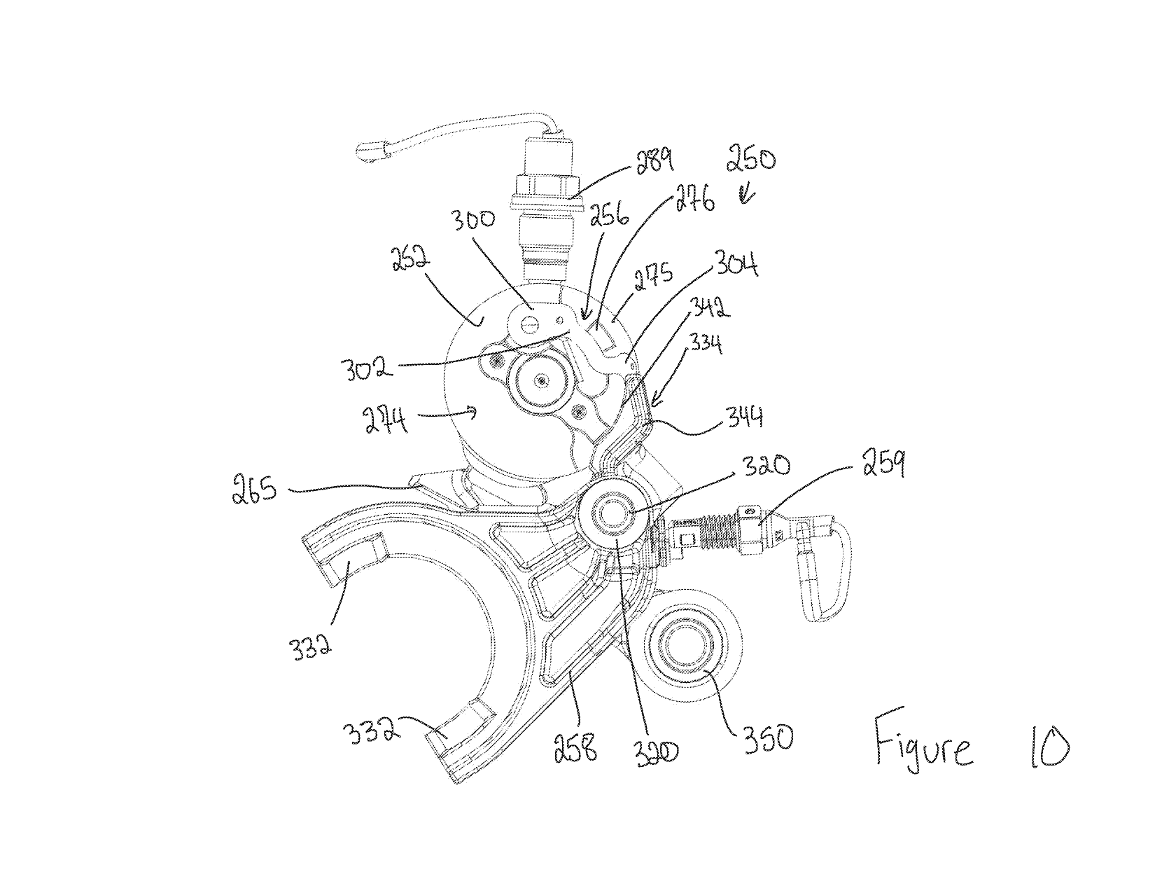

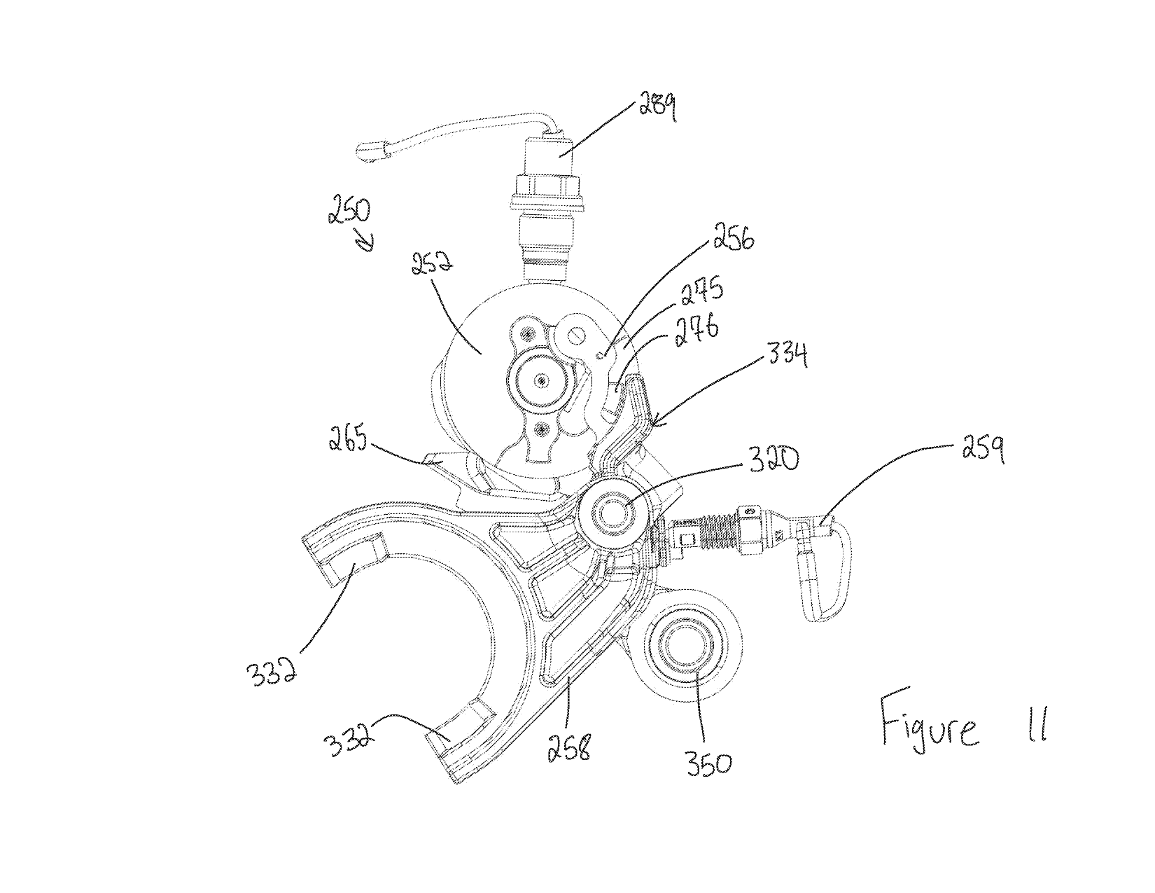

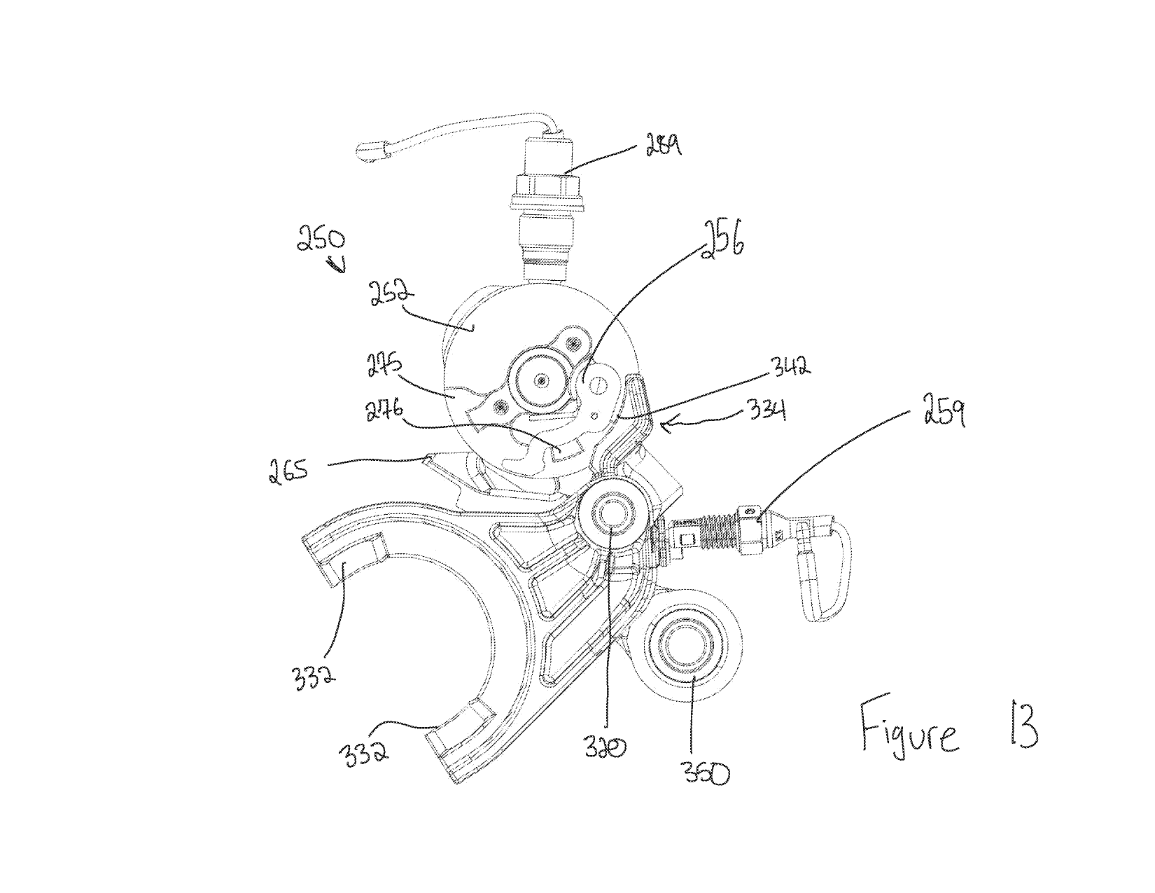

The shift drum 252 is connected to the shift drum shaft 260. In the present embodiment, the shift drum 252 is integral with the shift drum shaft 260. It is contemplated that the shift drum 252 could be fixedly rotationally connected to the shift drum shaft 260 differently. Thus, in response to the shift drum shaft 260 rotating, the shift drum 252 also rotates. The shift drum 252 is rotatable between a park position (FIGS. 6 and 10), a drive position (FIGS. 7 and 11) and a neutral position (FIGS. 9 and 13). It is contemplated that in some embodiments, the shift drum 252 could be rotatable between additional positions, or that the shift drum 252 could simply be rotatable between a drive position and a park position, or that the shift drum 252 could simply be rotatable between a neutral position and a drive position. The movement of the shift drum 252 will be described in greater detail below.

Referring to FIGS. 7, 10 and 17, the shift drum 252 is generally cylindrical, with a radial surface 270, an axial surface 272 and an axial surface 274 opposite to the axial surface 272.

The radial surface 270 defines a guiding groove 280. The guiding groove 280 extends along part of the circumference of the shift drum 252. It is contemplated that in some embodiments, the guiding groove 280 could extend more than 360 degrees about the shift drum 252. The guiding groove 280 has a narrow groove section 282 and a wide groove section 284. The narrow groove section 282 is axially narrower than the wide groove section 284. The narrow groove section 282 is aligned with one lateral side of the wide groove section 284. As will be described below, the guiding groove 280 is configured to receive part of the shift fork 258 therein.

The radial surface 270 further defines a park recess 286, a drive recess 287 and a neutral recess 288. The park, drive and neutral recesses 286, 287, 288 are angularly spaced from one another, and are configured to partially receive a ball plunger 289 of the transmission 100.

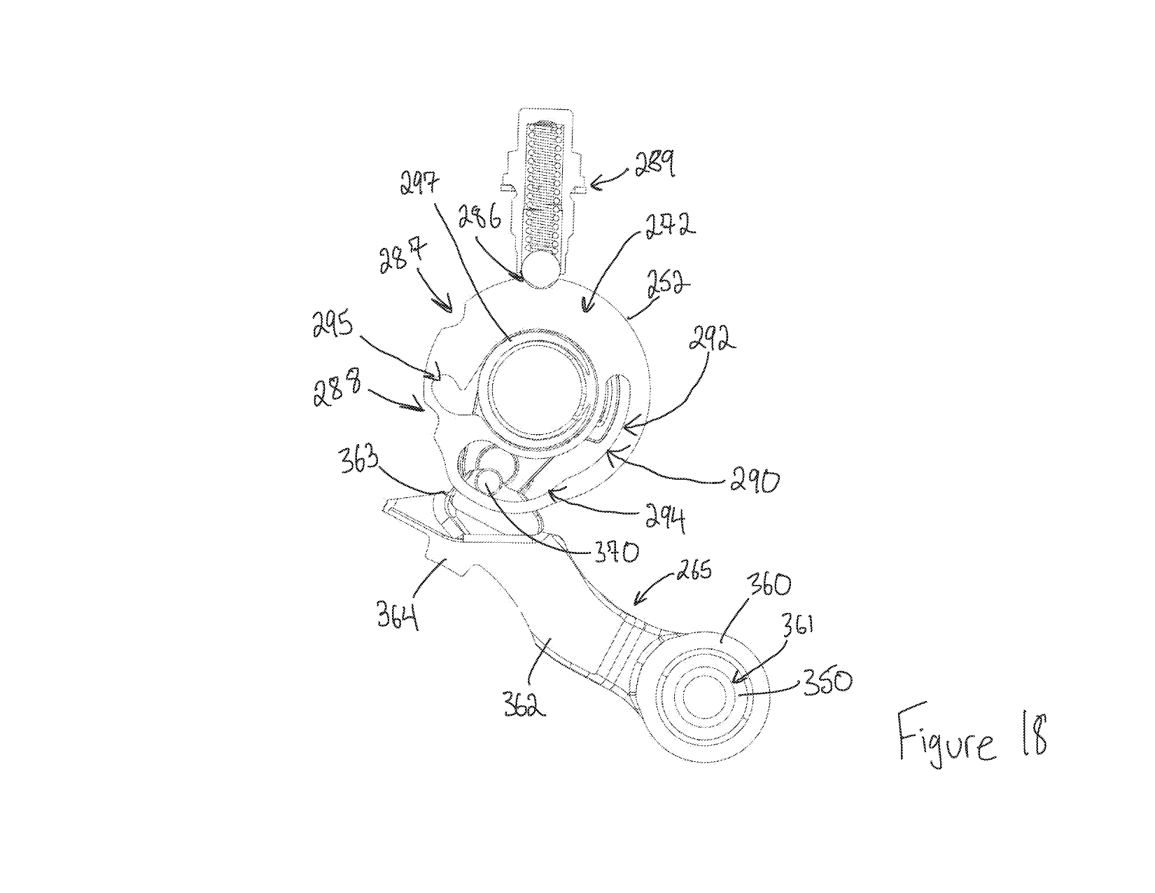

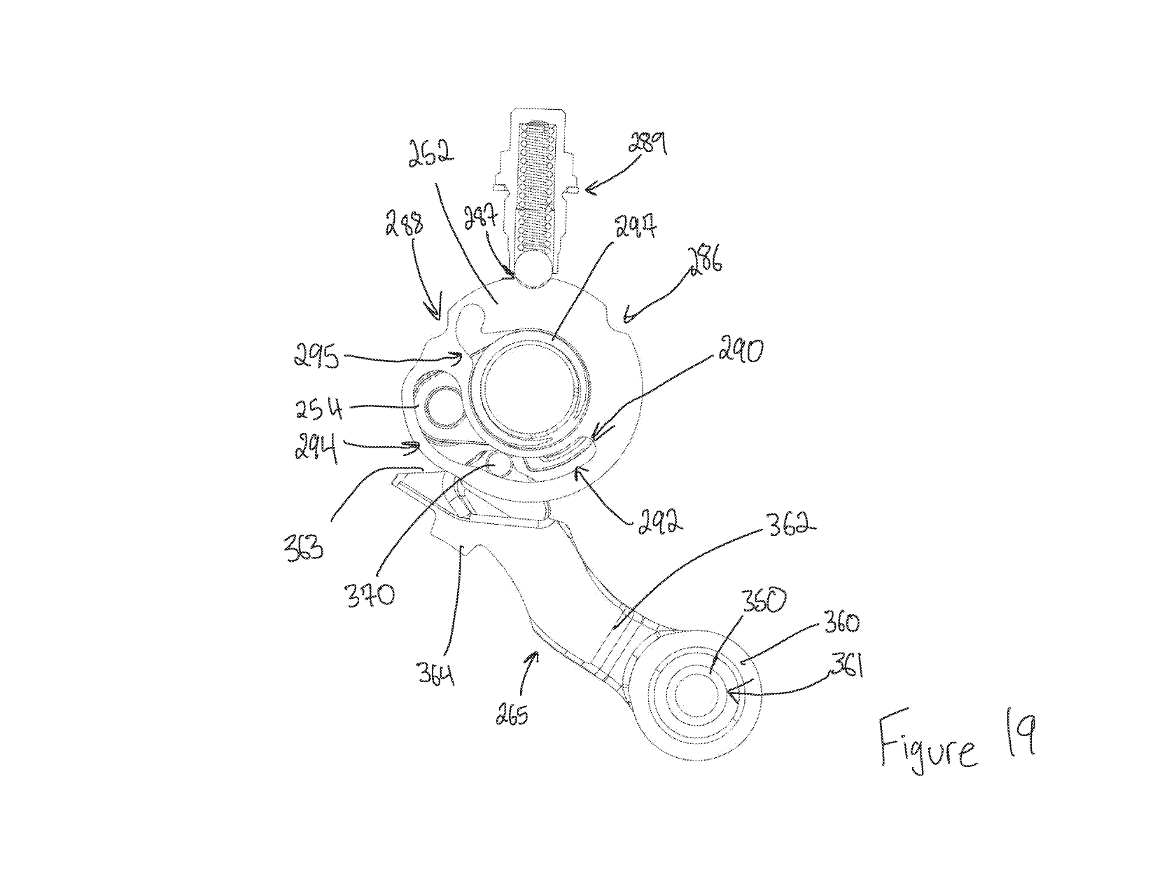

As shown in FIGS. 6 and 18, when the shift drum 252 is in the park position, the ball plunger 289 is received in the park recess 286. As shown in FIGS. 7 and 19, when the shift drum 252 is in the drive position, the ball plunger 289 is received in the drive recess 287. As shown in FIG. 9, when the shift drum 252 is in the neutral position, the ball plunger 289 is received in the neutral recess 288.

The ball plunger 289 can assist in maintaining a position of the shift drum 252 when received in one of the recesses 286, 287, 288. However, the force applied by the ball plunger 289 to maintain a position of the shift drum 252 can be overcome by the shift motor 262, such that the ball plunger 289 is configured to enable rotation of the shift drum 252 in response to the actuation of the shift motor 262. It is contemplated that the ball plunger 289 could be omitted.

Referring to FIGS. 18 and 19, the axial surface 272 defines a side groove 290. The side groove 290 extends arcuately about 120 degrees with respect to a center of the shift drum 252. It is contemplated that the side groove 290 could extend more or less than 120 degrees. The side groove 290 has a narrow groove section 292 and a wide groove section 294. The narrow groove section 292 is radially narrower than the wide groove section 294. The side groove 290 is partially angularly aligned with the guiding groove 280. More specifically, the narrow groove section 292 is angularly aligned with the wide groove section 284. As will be described below, the side groove 290 is configured to receive part of the parking lever 265 therein.

Radially inwardly from the side groove 290, the axial surface 272 defines a side groove 295. As will be described below, the side groove 295 is configured to receive a parking biasing member 297.

Referring to FIGS. 10 to 15 and 17, the axial surface 274 has a raised portion 275 that extends in the axial direction. In some embodiments, the raised portion 275 may be omitted. The raised portion 275 has a stopper 276 extending therefrom. As will be described in greater detail below, the stopper 276 is configured to engage with the retainer 256 for stopping movement thereof.

Referring to FIGS. 6 to 9, the parking cam 254 is connected to the axial surface 272 of the shift drum 252. The parking cam 254 is rotatable between a park cam position (shown in FIG. 6) and various move cam positions (shown in FIGS. 7 to 9). The parking cam 254 is operatively connected to the parking biasing member 297 that is received in the side groove 295. The parking biasing member 297 is a torsion spring 297. The torsion spring 297 biases the parking cam 254 toward the park cam position.

The parking cam 254 has a roller 298 on its distal end. The roller 298 is configured to roll on the parking lever 265. More specifically, as will be described in greater detail below, when the parking cam 254 is in the park cam position, the roller 298 engages the parking lever 265, and when the parking cam 254 is offset from the park cam position (i.e., is in one of the move positions), the roller 298 does not engage the parking lever 265 (e.g., could be spaced therefrom).

The parking cam 254 also has a sensing portion 299 configured to selectively operatively engage a position sensor 255. The position sensor 255 is configured to sense a position of the parking cam 254. The position sensor 255 is communicatively connected to the motor controller 32. In some embodiments, depending on a reading of the position sensor 255, the motor controller 32 may be configured to cause one of the displays and gauges 29 to display that the shifting assembly 250 of the transmission 100 is in the park configuration when the parking cam 254 engages the sensor 255.

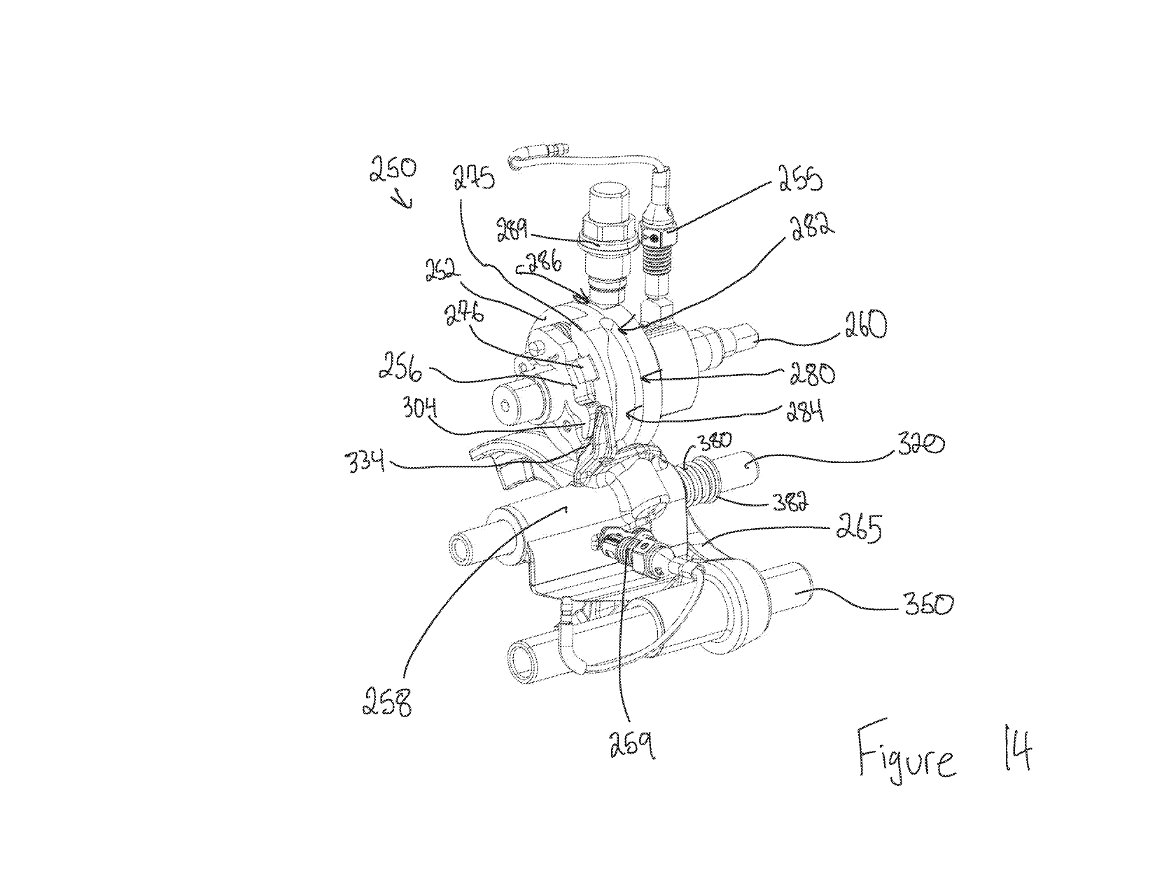

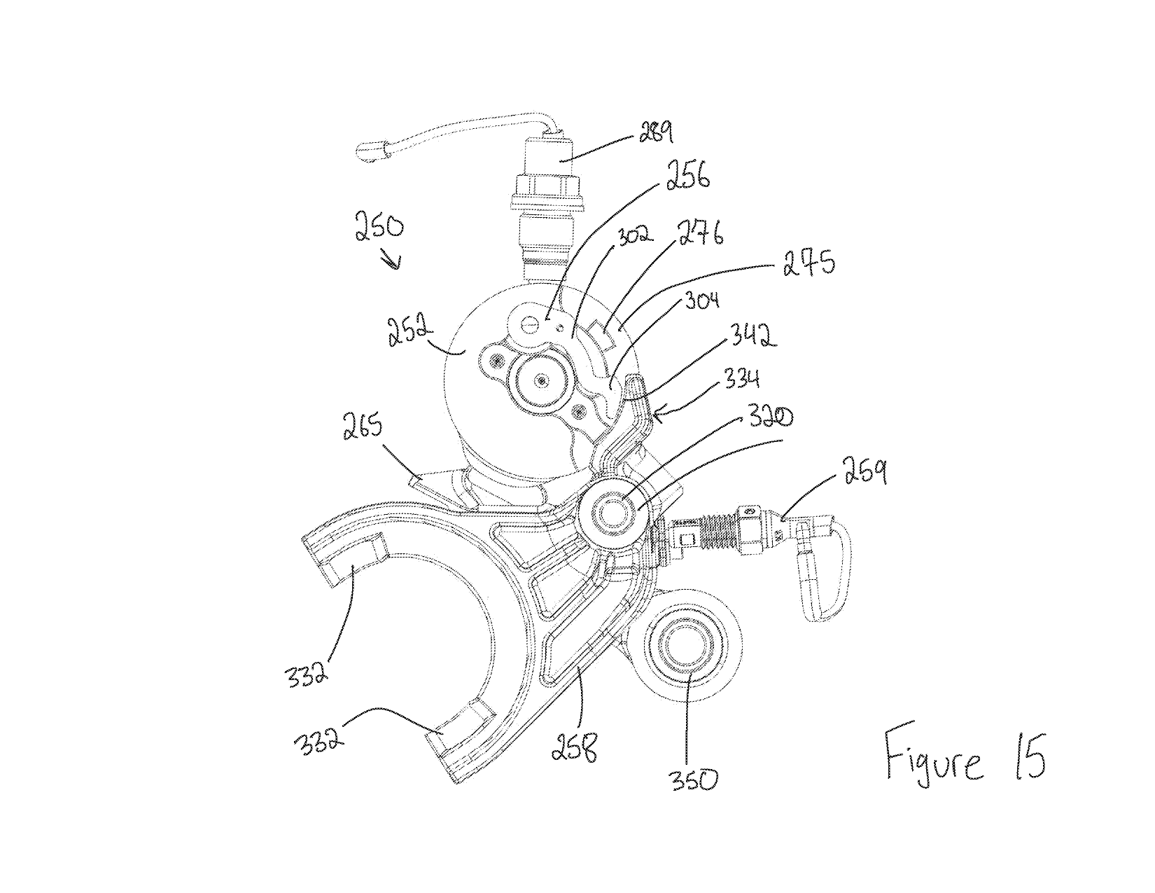

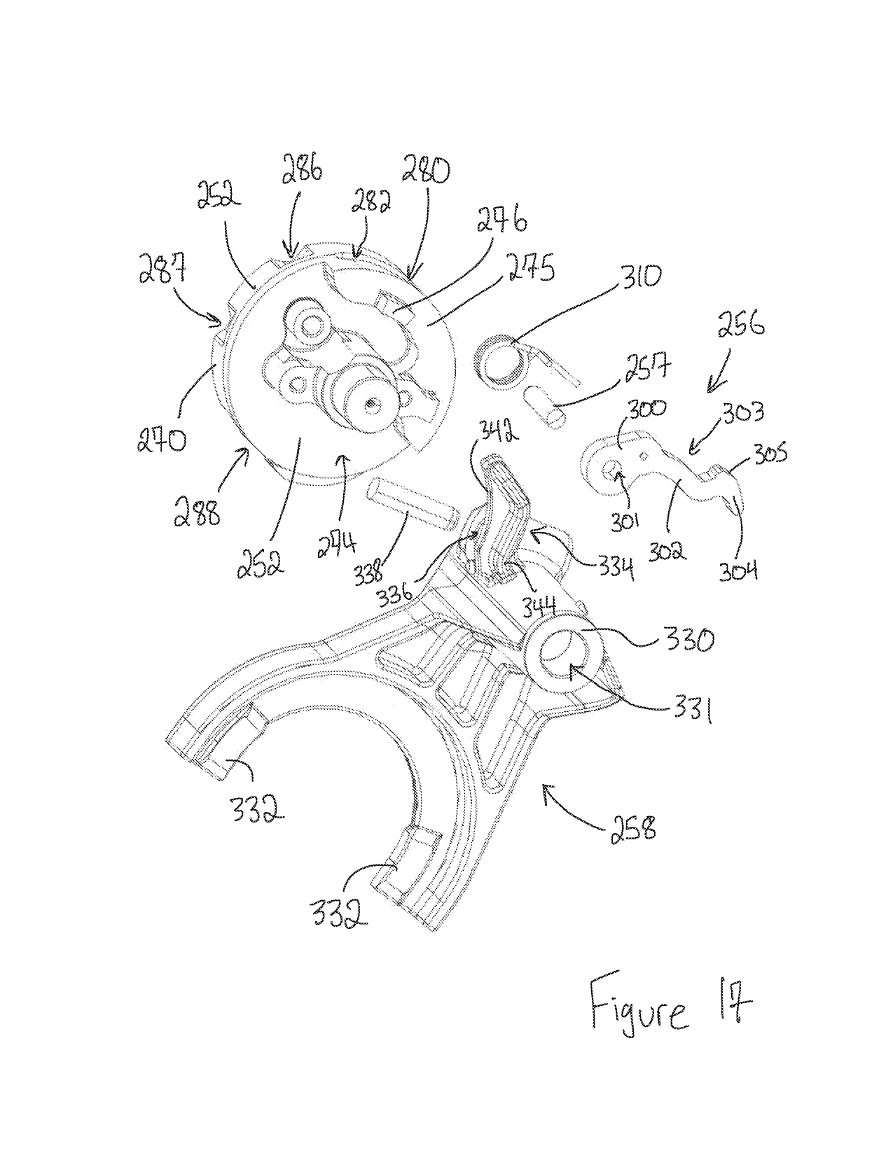

Referring to FIG. 17, the retainer 256, which is configured to engage with the shift fork 258, will now be described in greater detail. The retainer 256 is pivotally connected to the axial surface 274 of the shift drum 252 via a pin 257. The retainer 256 is moveable relative to the shift drum 252 between an extended position (FIGS. 10 to 13) and a retracted position (FIGS. 14 and 15). In the present embodiment, the retainer 256 is a lever. It is contemplated that in some embodiments, the retainer 256 could be connected to the axial surface 274 differently. For example, the retainer 256 could be an axially retractable retainer.

The retainer 256 has a base 300, an arm 302 and a head 304. The base 300 defines an aperture 301 configured to receive the pin 257 therein. The arm 302 extends from the base 300 and defines a recess 303. As will be described below, the arm 302 and the recess 303 are shaped and configured such that when the retainer 256 is in the extended position, the stopper 276 is received in the recess 303 and the arm 302 abuts the stopper 276. The head 304 has an upper surface 305. In some embodiments, the upper surface 305 may be partially arcuate. It is contemplated that the shape of the retainer 256 may vary without departing from the scope of the present technology. The retainer 256 also abuts a holding plate 309 mounted to the shift drum shaft 260. The holding plate 309 keeps the retainer 256 axially in place, and can allow for convenient pre-assembly.

The retainer 256 is connected to a retainer biasing member 310. The retainer biasing member 310 is a torsion spring 310. It is contemplated that in other embodiments, the retainer biasing member 310 could be another type of resilient member such as a polymeric material. The torsion spring 310 biases the retainer 256 towards the extended position.

When the retainer 256 is in the extended position, the stopper 276 is received in the recess 303 and abuts the arm 302. Thus, the stopper 276 stops the retainer 256 in the extended position. When the retainer 256 is in the retracted position, the arm 302 is spaced from the stopper 276.

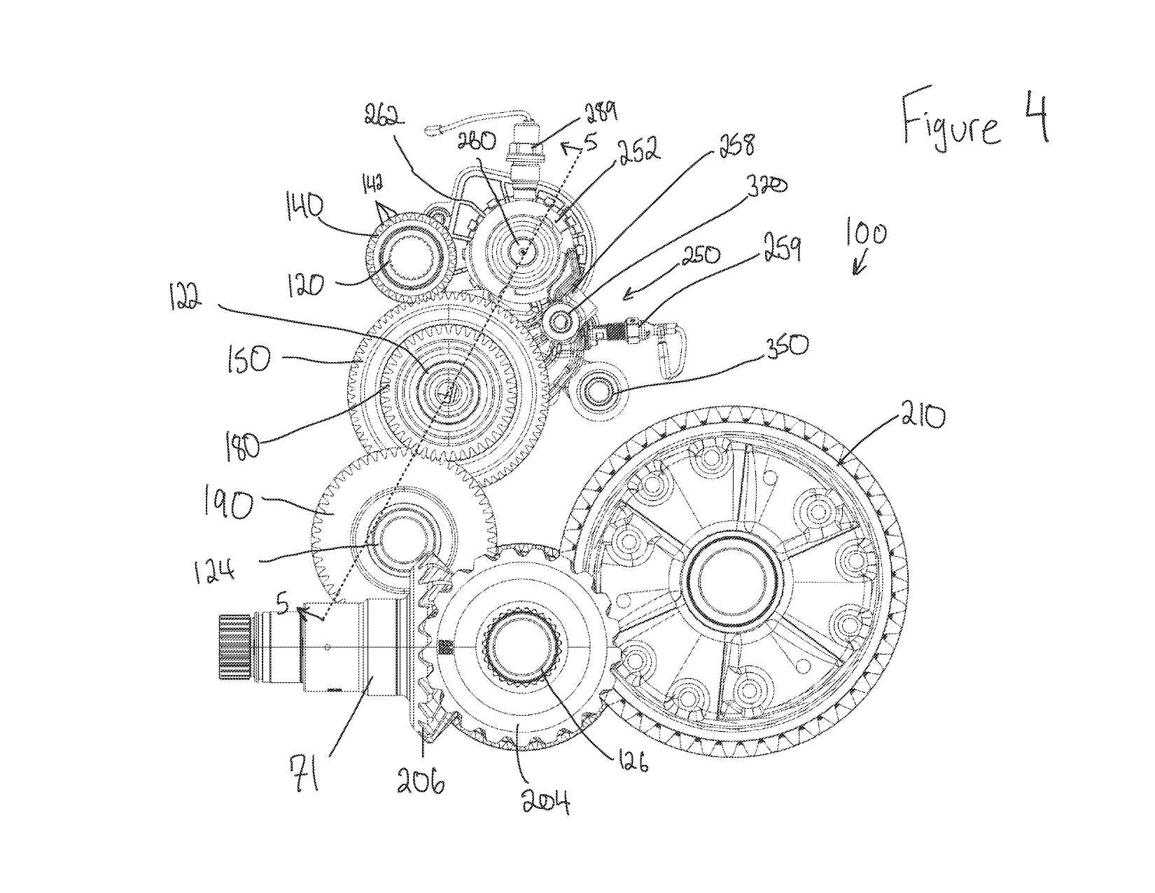

Referring to FIGS. 6 to 9, a shift fork rod 320 extends generally parallel to the shift drum shaft 260. As best seen in FIG. 4, the shift fork rod 320 is positioned longitudinally rearward of and vertically lower than the shift drum shaft 260. It is contemplated that the shift fork rod 320 could be positioned differently.

The shift fork 258 is connected to the shift fork rod 320. More specifically, the shift fork 258 is axially slidingly mounted on the shift fork rod 320. The shift fork 258 is moveable between an engaged fork position (FIGS. 6 to 8) and a disengaged fork position (FIG. 9).

Referring to FIG. 17, the shift fork 258 has a base 330, two curved prongs 332 connected to the base 330, an abutting arm 334 also connected to base 330 and a pin 338. The base 330 defines an aperture 331 in which the shift fork rod 320 is received.

The two curved prongs 332 are received in the recess 171 defined between the dog gear 160 and the park gear 170. As will be described below, this operatively connects the shift fork 258 to the dog gear 160 such that movement of the shift fork 258 causes movement of the dog gear 160.

The abutting arm 334 extends from the base 330. The abutting arm 334 has a side surface 340. As will be described below, the side surface 340 (shown in FIGS. 6 to 9) can, in some instances, abut against the retainer 256. The abutting arm 334 further has a front surface 342. The front surface 342 is generally arcuate. As will be described in greater detail below, the front surface 342 can, in some instances, abut against the upper surface 305 of the head 304 to slidingly guide the retainer 256 toward the retracted position. The abutting arm 334 further has a reinforcing rib 344.

The pin 338 is received in an aperture 336 (FIG. 17), extends from the base 330, and is received in the guiding groove 280. As will be described below, the engagement between the pin 338 and the guiding groove 280 causes movement of shift fork 258 in response to a rotation of the shift drum 252.

The shift fork 258 is operatively connected to the dog gear 160 via the prongs 332, such that the shift fork 258 can cause axial translation of the dog gear 160. More specifically, when the shift fork 258 is in the engaged fork position (shown in FIGS. 6 to 8), the dog gear 160 is in the engaged dog position, and when the shift fork 258 is in the disengaged fork position (shown in FIG. 9), the dog gear 160 is in the disengaged dog position. As the shift fork 258 moves between the engaged and disengaged fork positions, the prongs 332 abut against the dog gear 160 or the park gear 170 for causing movement thereof.

A position sensor 259 is operatively connected to the shift fork 258 and is configured to sense a position thereof. The position sensor 259 is communicatively connected to the motor controller 32. In some embodiments, depending on a reading of the position sensor 259, the motor controller 32 may be configured to cause one of the displays and gauges 29 to display that the shifting assembly 250 of the transmission 100 is in the neutral configuration when the shift fork 258 is in the disengaged fork position, that the shifting assembly 250 is in the drive configuration when the shift fork 258 is in the engaged fork position and when the parking cam 254 is in the move position (e.g., via the position sensor 255) and that the shifting assembly 250 is in the park configuration when the parking cam 254 is in the cam park position (via the sensor 255).

The shifting assembly 250 also includes a shift fork biasing member 380. In the present embodiment, the shift fork biasing member 380 is a shift fork spring 380. The shift fork spring 380 is connected to the shift fork rod 320. More specifically, the shift fork spring 380 is wound around the shift fork rod 320. One end of the shift fork spring 380 is connected to a retaining ring 382. The retaining ring 382 fixes that end of the shift fork spring 380 to the shift fork rod 320. The other end of the shift fork spring 380 is engaged to the shift fork 258. The shift fork spring 380 biases the shift fork 258 towards the engaged shift fork position.

A parking rod 350 extends generally parallel to the shift fork rod 320. As best seen in FIG. 4, the parking rod 350 is positioned longitudinally rearward of and vertically lower than the shift fork rod 320. It is contemplated that the parking rod 350 could be positioned differently.

Referring to FIGS. 18 and 19, the parking lever 265 is pivotally connected to the parking rod 350, such that the parking lever 265 is moveable between a park position (FIGS. 6, 10, 14, 15 and 18) and a move position (FIGS. 7 to 9, 11 to 13, 16 and 19). The parking lever 265 has a base 360, an arm 362 and a tooth 364.

The base 360 defines an aperture 361 and receives the parking rod 350 therein. It is contemplated that in some embodiments, the parking lever 265 may be connected to the parking rod 350 via a bearing.

The arm 362 extends from the base 360 toward the park gear 170. The arm 362 has an upper surface 363 upon which the roller 298 of the parking cam 254 is configured to roll. The arm 362 further has a parking pin 370 that extends in the lateral direction, and that is received in the side groove 290. The engagement between the parking pin 370 and the side groove 290 can assist in guiding movement of the parking lever 265 between the park position and the move position.

The tooth 364 is configured to engage with the radial teeth 172 of the park gear 170. More specifically, when the parking lever 265 is in the park position, the tooth 364 is received between two radial teeth 172 of the park gear 170, which prevents rotation of the park gear 170, and thus prevents rotation of the countershaft 122. When the parking lever 265 is in the move position, the tooth 365 is not engaged with the radial teeth 172 of the park gear 170, such that rotation of the countershaft 122 is not impeded.

In the present embodiment, the input gear 140, the drive gear 150, the intermediate gear 180, the gear 190, the gear 192, the output gear 200, the pinion 202 and the rear differential gear 210 are helical gears. The bevel gears 204, 206 are spiral bevel gears. Helical gears and spiral bevel gears can provide smoother and quieter operation than spur gears, and can transmit larger forces. It is contemplated that in other embodiments, two or more of the input gear 140, the drive gear 150, the intermediate gear 180, the gear 190, the gear 192, the output gear 200, the pinion 202 and the rear differential gear 210 could be spur gears. It is also contemplated that the bevel gears 204, 206 could be straight bevel gears.

Referring to FIGS. 6, 10 and 18, the shifting assembly 250 in the park configuration will now be described. As described above, when the shift drum 252 is in the park position, the ball plunger 289 is received in the park recess 286.

When the shift drum 252 is in the park position, the pin 338 of the shift fork 258 is received in the wide groove section 284 of the guiding groove 280. Due to the bias applied by the shift fork spring 380, the shift fork 258 is in the engaged shift fork position. Since the shift fork 258 is in the engaged shift fork position, the dog gear 160 is in the engaged dog position. Thus, the dog gear 160 is drivingly engaged to the drive gear 150, such that the drive gear 150 and the countershaft 122 are rotationally fixed relative to one another.

When the shift drum 252 is in the park position, the parking pin 370 of the parking lever 265 is received in the wide groove section 294 of the side groove 290, such that the parking pin 370 can move in a radial direction (i.e., the parking lever 265 is moveable between the park position and the move position). Thus, the parking lever 265 can move between the parked position and the move position. Since the parking cam 254 is biased toward the park cam position due to the torsion spring 297, the parking cam 254 rotates such that the roller 298 rolls on the upper surface 363 of the arm 362, which causes the parking lever 265 to move to the park position.

When the parking lever 265 is in the park position, the tooth 364 is received between two radial teeth 172 of the park gear 170, and the engagement between the parking lever 265 and the park gear 170 prevents the park gear 170, and thus the dog gear 160, from rotating. Since all the shafts are drivingly connected to one another, and the countershaft 122 is prevented from rotating, the output shaft 124 is also prevented from rotating.

In some instances, initially, the parking lever 265 may not reach the park position, as the tooth 364 may abut against one of the radial teeth 172 (i.e., the tooth 364 is not received between two radial teeth 172). In such instances, due to the bias applied by the parking biasing member 297 on the parking cam 254, as soon as the park gear 170 rotates slightly and the tooth 364 can be received between two radial teeth 172, the parking lever 265 moves to the park position.

From the park configuration, the shifting assembly 250 can be moved to the drive configuration by actuating the shift motor 262, which causes the shift drum 252 to rotate about the shift drum axis 261 from the park position to the drive position (i.e. clockwise with reference to FIG. 10).

As the shift drum 252 starts rotating from the park position toward the drive position, the parking cam 254 moves away from the parking cam position, and the parking lever 265 moves toward the move position. More specifically, the parking pin 370 moves from the wide groove section 294 to the narrow groove section 292, which causes the parking lever 265 to move toward the move position, and prevents the parking lever 265 from accidentally moving back toward the park position. Thus, the shafts of the transmission 100 can rotate. Also, while the shift drum 252 rotates, the pin 338 moves along the guiding groove 280.

Referring to FIGS. 7 and 11, the shifting assembly 250 in the drive configuration will now be described. As described above, when the shift drum 252 is in the drive position, the ball plunger 289 is received in the drive recess 287.

When the shift drum 252 is in the drive position, the pin 338 of the shift fork 258 is still received in the wide groove section 284 of the guiding groove 280, and due to the bias applied by the shift fork spring 380, the shift fork 258 is still in the engaged shift fork position. Thus, the dog gear 160 is still in the engaged dog position. Thus, the dog gear 160 is drivingly engaged to the drive gear 150, which results in the drive gear 150 and the countershaft 122 being rotationally fixed relative to one another. As a result, in response to the motor 30 being actuated and causing rotation of the input shaft 120, the output shaft 126, and thus the driveshaft 70 and the rear differential gear 210 also rotate.

The retainer 256 prevents the shift fork 258 from moving toward the disengaged fork position. More specifically, the head 304 is disposed laterally between the shift drum 252 and the abutting arm 334 of the shift fork 258. Thus, if the shift fork 258 is caused to move toward the disengaged fork position, for example due to a shock, the retainer 256 abuts against the side surface 340 of the abutting arm 334, which prevents the shift fork 258 from moving toward the disengaged fork position.

From the drive configuration, the shifting assembly 250 can be moved to the neutral configuration by actuating the shift motor 262, and cause the shift drum 252 to rotate about the shift drum axis 261 from the drive position to the neutral position (i.e. clockwise with reference to FIG. 11).

As the shift drum 252 rotates from the drive position toward the neutral position, the parking cam 254 remains in the move position, and the parking pin 370 remains in the narrow groove section 292, such that the parking lever 265 remains in the move position.

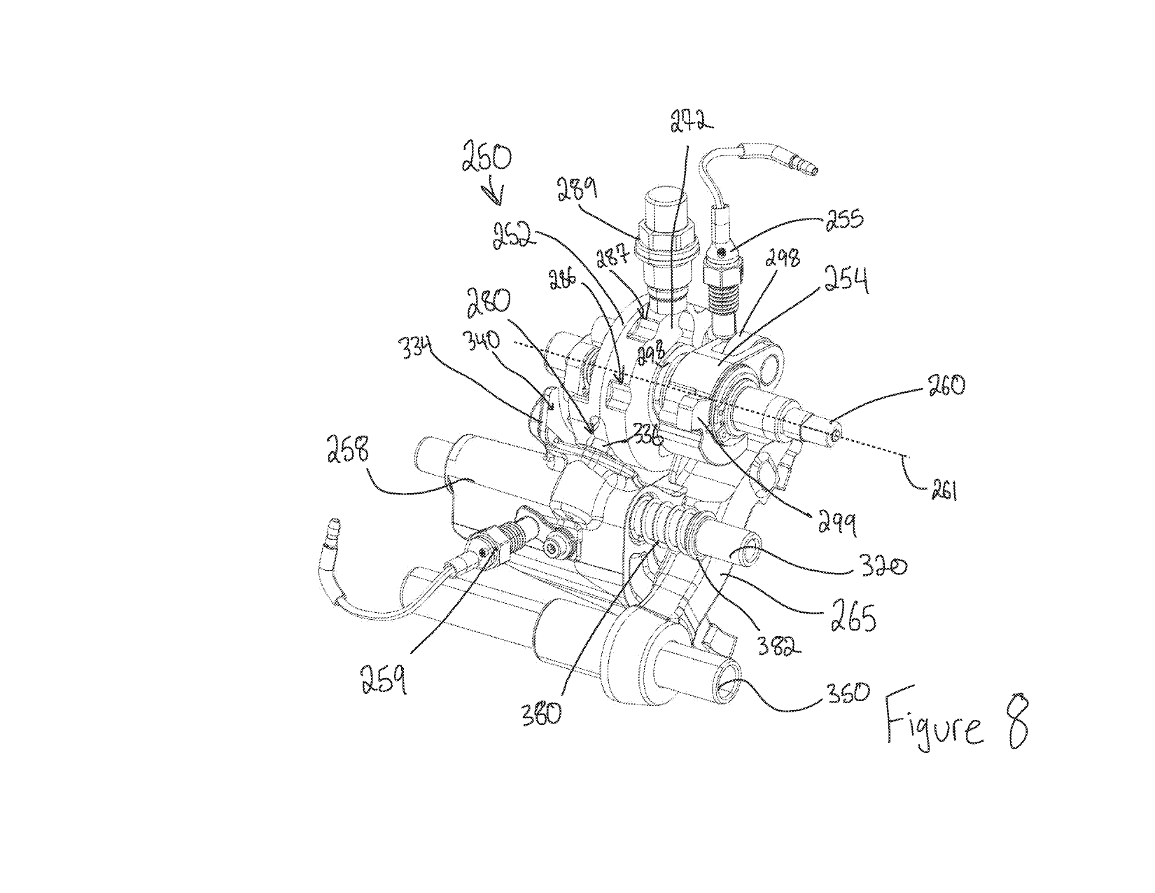

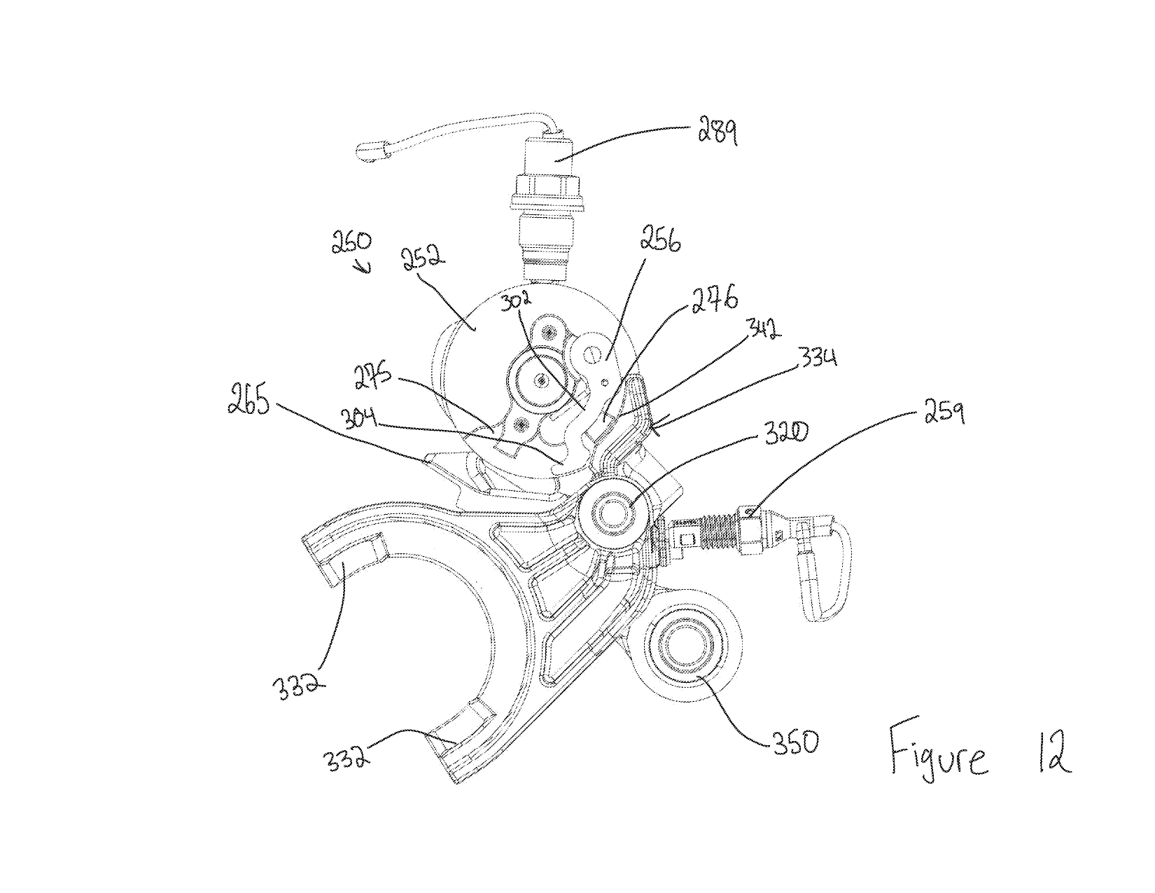

As the shift drum 252 is rotating from the drive position toward the neutral position, the shift drum 252 reaches an unlocked drive position (shown in FIGS. 8 and 12). When the shift drum 252 is in the unlocked drive position, the retainer 256, while still in the extended position, has moved with the shift drum 252 so as to be offset from the abutting arm 334. The offset is such that the retainer 256 permits movement of the shift fork 258 toward the disengaged fork position. However, due to the biasing forces applied by the shift fork spring 380, the shift fork 258 remains in the engaged fork position.

Eventually, as the shift drum 252 continues to rotate, the pin 338 is guided into the narrow groove section 292. Due to the lateral positioning of the narrow groove section 292, the shift fork 258 is configured to slide axially along the shift fork rod 320 to the disengaged shift fork position. The engagement between the pin 338 and the guiding groove 280 overcomes the biasing force applied by the shift fork spring 380. As described above, the retainer 256 does not prevent movement of the shift fork 258 from the engaged fork position to the disengaged fork position. Movement of the shift fork 258 to the disengaged fork position causes the dog gear 160 to move to the disengaged dog position, and therefore disengages the drive gear 150.

Referring to FIGS. 9 and 13, the shifting assembly 250 in the neutral configuration will now be described. When the shift drum 252 is in the neutral position, the ball plunger 289 is received in the neutral recess 288, as described above.

The parking cam 254 remains in the move position, and the parking pin 370 remains in the narrow groove section 292, such that the parking lever 265 remains in the move position.

The pin 338 of the shift fork 258 is received in the narrow groove section 292, and the shift fork 258 is in the disengaged shift fork position, which further causes the shift fork spring 380 to be compressed.

The dog gear 160 is in the disengaged dog position, such that the dog gear 160 is drivingly disengaged from the drive gear 150, which results in the drive gear 150 being free to rotate relative to the countershaft 122. As a result, no driving torque can be transferred from the motor 30 to the driveshaft 70 and to the rear differential gear 210 via the transmission 100, but the vehicle 10 can be towed or pushed.

From the neutral configuration, the shifting assembly 250 can be moved to the drive configuration by actuating the shift motor 262, and cause the shift drum 252 to rotate about the shift drum axis 261 from the neutral position to the drive position (i.e. counter-clockwise with reference to FIG. 13).

As the shift drum 252 rotates from the neutral position toward the drive position, the parking cam 254 remains in the move position, the parking pin 370 remains in the narrow groove section 292 and the parking lever 265 remains in the move position.

Once the pin 338 exits the narrow groove section 282, the shift fork spring 380 biases the shift fork 258 toward the engaged fork position.

In some scenarios, the shift fork 258 reaches the engaged fork position, such that the dog gear 160 reaches the engaged dog position. Eventually, the shift drum 252 reaches the drive position, and the shifting assembly 250 is in the drive configuration, which is as described above.

In other scenarios, the shift fork 258 moves to an intermediate fork position, which is shown in FIGS. 14 and 15. More specifically, in FIGS. 14 and 15, the shift drum 252 has further been rotated to reach the park position, and the parking lever 265 has been moved to the park position. Thus, it will be appreciated that the parking lever 265 can be moved to the park position even if the shift fork 258 is not in the engaged fork position. It is contemplated, that the shift fork 258 may be in the intermediate fork position while the shift drum 252 is in the drive position. The intermediate fork position is disposed between the engaged fork position and the disengaged fork position. The intermediate fork position occurs when the shift fork 258 does not reach the engaged fork position, because the shift fork 258 moves with the dog gear 160, and the dog gear 160 is prevented from reaching the engaged dog position because of the alignment between the axial teeth 164 of the dog gear 160 and the axial teeth 154 of the drive gear 150. Instead of meshing with one another, the axial teeth 154, 164 abut against one another. However, the shift drum 252 continues to rotate until the drive position is reached.

When the shift fork 258 is in the intermediate fork position, the front surface 342 of the arm 334 is laterally aligned with the head 304 of the retainer 256. As the shift drum 252 is rotating, the front surface 342 of the arm 334 first abuts against the upper surface 305 of the head 304, and eventually causes the retainer 256 to pivot about the pin 257 toward the retracted position. The arcuate configuration of the upper surface 305 and the front surface 342 can assist in ensuring smooth relative movement therebetween.

As soon as the dog gear 160 and the drive gear 150 rotate relative to one another such that the axial teeth 154, 164 are no longer misaligned, the biasing force applied by the shift fork spring 380 causes the shift fork 258 to move toward the engaged shift fork position, and causes the dog gear 160 to move toward the engaged dog position.

With the shift fork 258 moving in the engaged fork position, the arm 334 becomes laterally offset from the retainer 256, such that the retainer 256 is biased by the retainer biasing member 310 to move back toward the extended position as shown in FIG. 11, thereby preventing the shift fork 258 from moving toward the disengaged fork position. The stopper 276 stops the retainer 256 at the extended position.

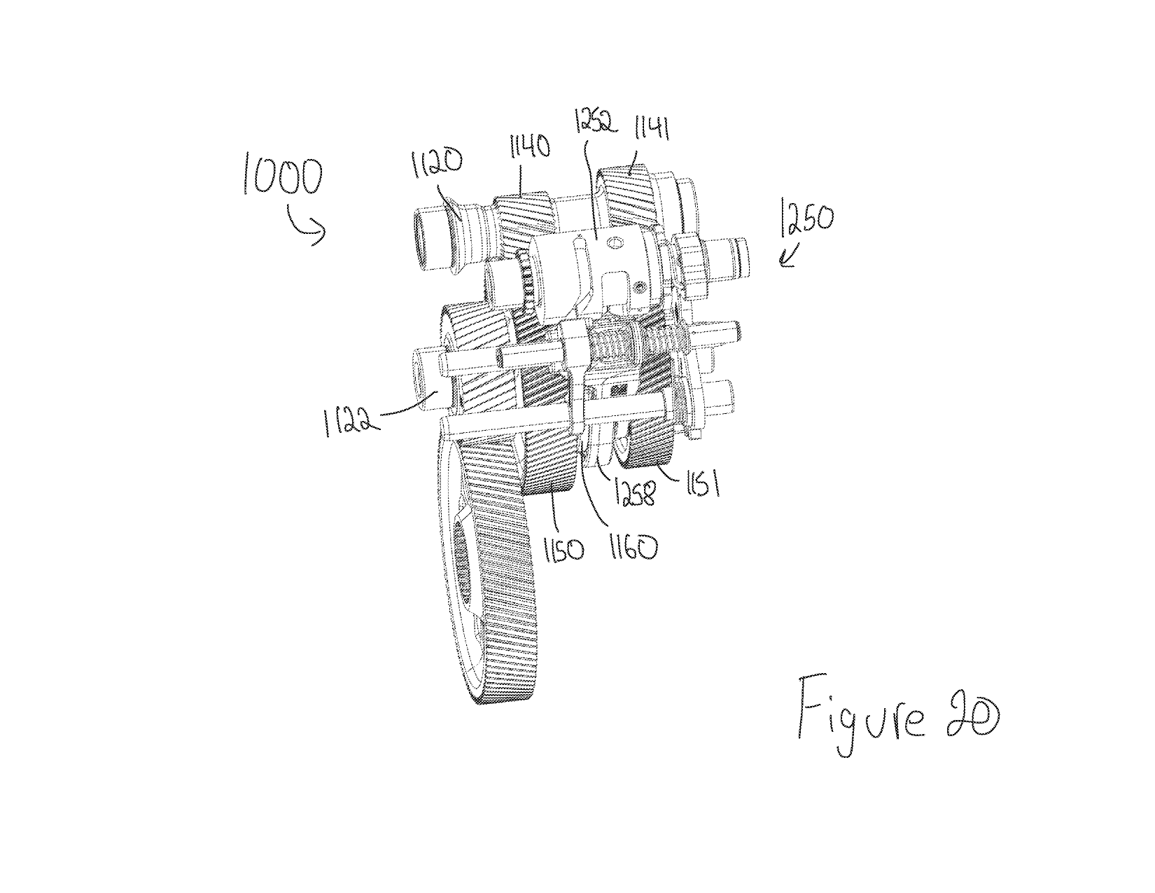

Referring to FIG. 20, a transmission 1000, which is an alternative embodiment of the transmission 100, is shown. Features of the transmission 1000 similar to those of the transmission 100 will not be re-described herewith.

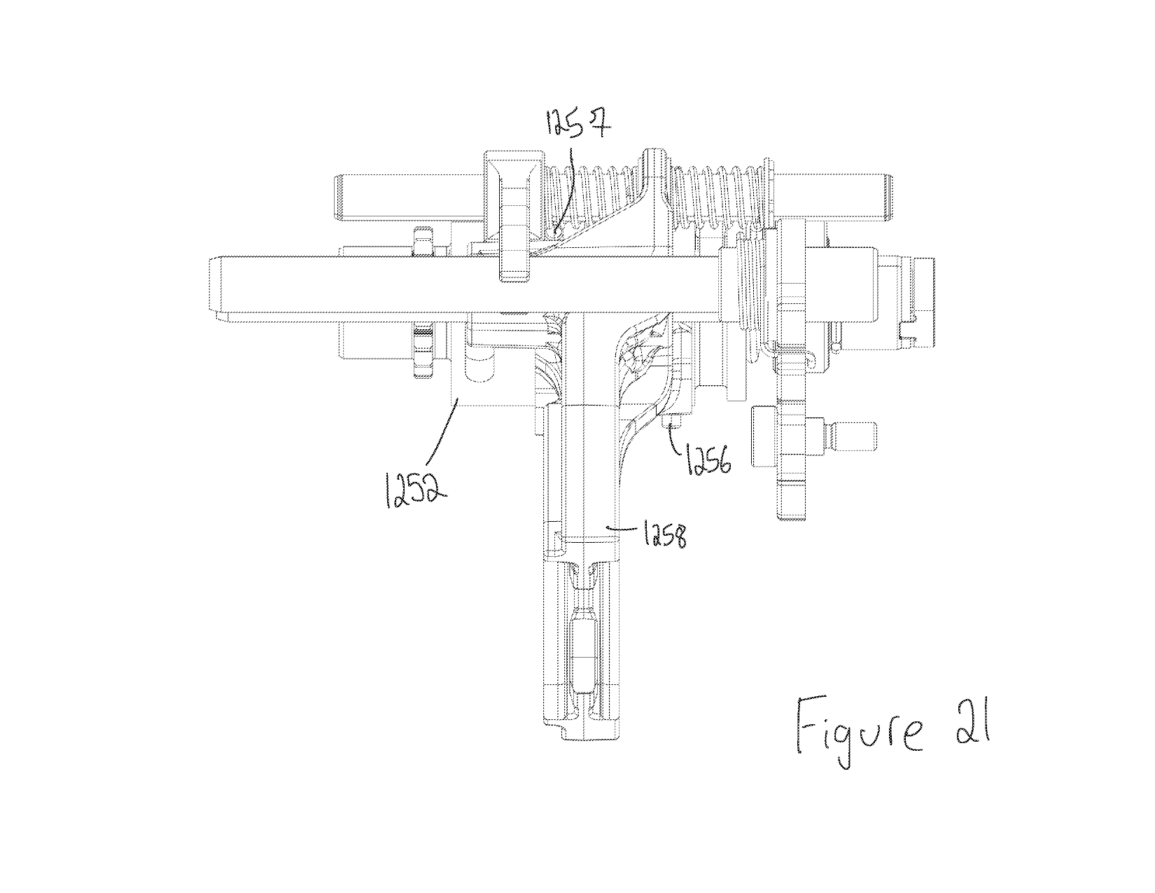

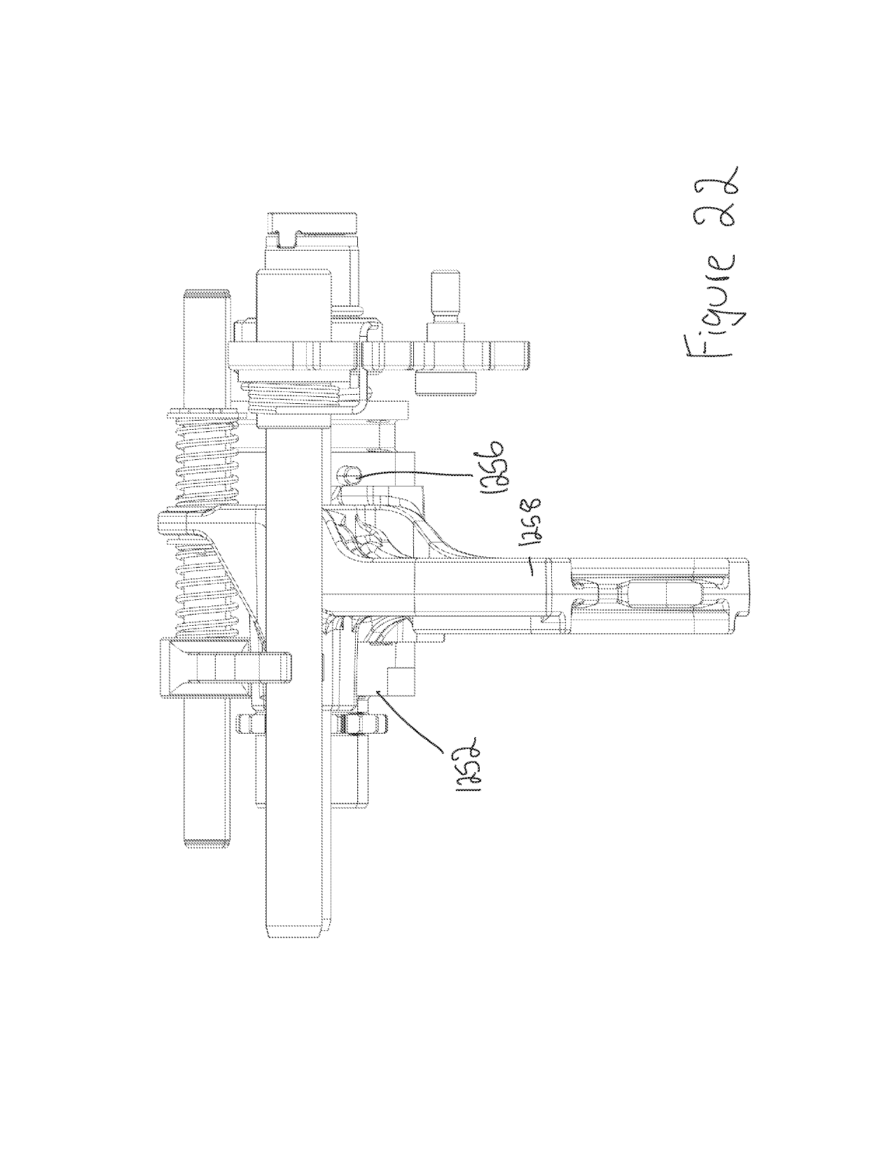

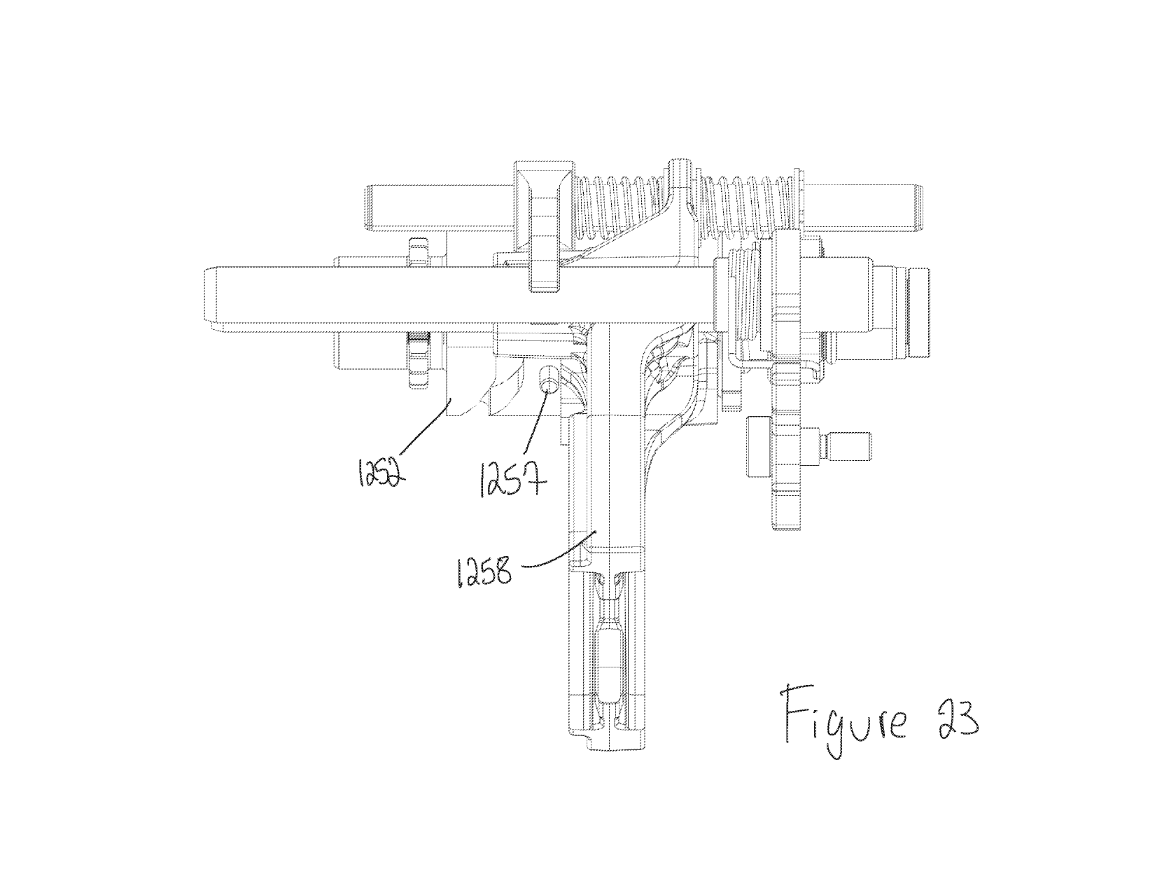

The transmission 1000 notably differs from the transmission 100 in that a shifting assembly 1250 of the transmission 1000 can be selectively arranged between a park configuration, a low-gear configuration (FIG. 22), a high-gear configuration (FIG. 23) and a neutral configuration (FIGS. 20 and 21). Accordingly, an input shaft 1120 of the transmission 1000 has a low gear 1140 and a high gear 1141, and a shaft 1122 has a primary gear 1150 drivingly engaged to the low gear 1140 and a secondary gear 1151 drivingly engaged to the high gear 1141. In this embodiment, a dog gear 1160 is selectively movable by a shift fork 1258. The dog gear 1160 is movable between a primary engaged dog position, in which the dog gear 1160 is drivingly engaged to the primary gear 1150, a secondary engaged dog position, in which the dog gear 1160 is drivingly engaged to the secondary gear 1151, and a disengaged dog position.

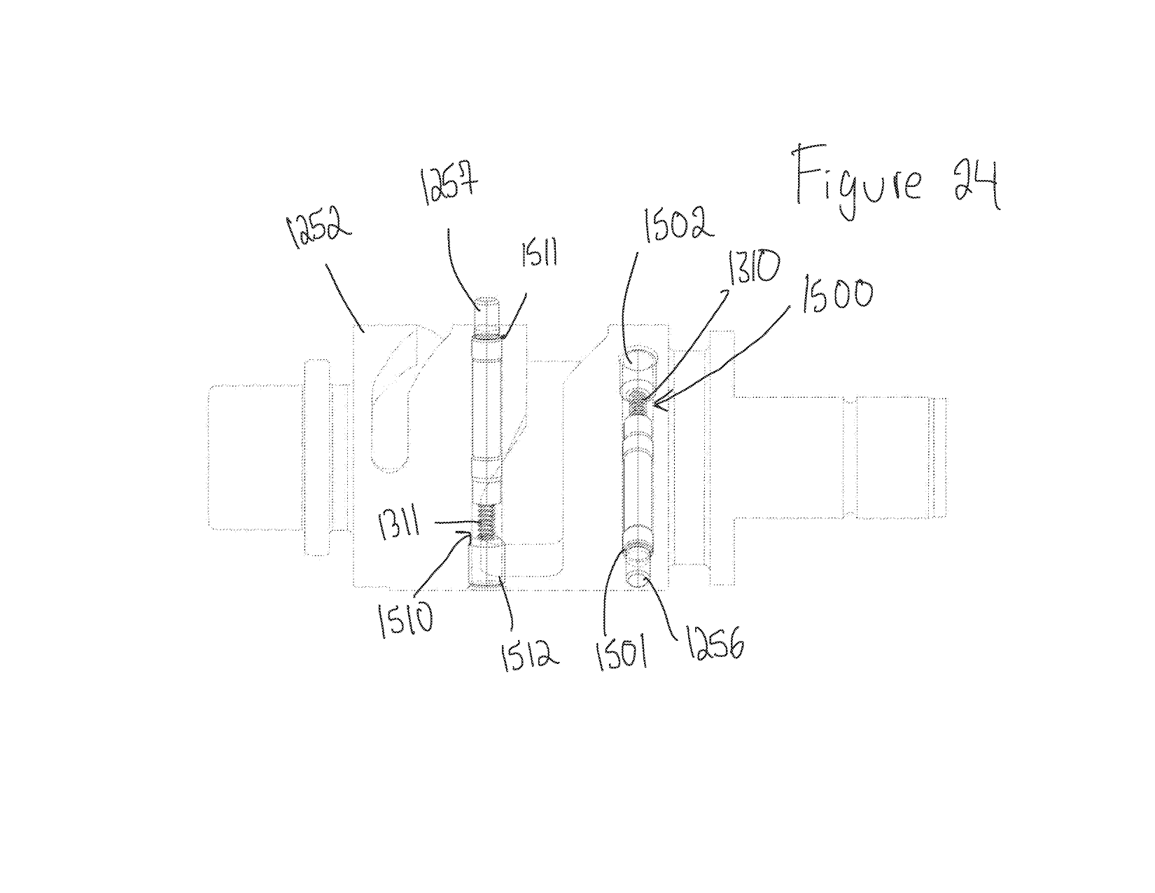

The shifting assembly 1250 includes a shift drum 1252. Additionally, instead of the retainer 256 and the retainer biasing member 310, the shifting assembly 1250 includes, best seen in FIG. 24, a primary retainer pin 1256, a primary retainer biasing member 1310, a secondary retainer pin 1257 and a secondary retainer biasing member 1311.

The shift drum 1252 defines a channel 1500 in which the primary retainer pin 1256 and the primary retainer biasing member 1310 are received. More specifically, the channel 1500 is a through channel, and passes through a radial center point of the shift drum 1252. It is contemplated that the channel 1500 may not be a through channel. One end of the channel 1500 is closed by a fastener 1502. The fastener 1502 engages the primary retainer biasing member 1310. The primary retainer biasing member 1310 is further engaged to the primary retainer pin 1256. The primary retainer pin 1256 partially extends out of the channel 1500. A lip 1501 defined by the shift drum 1252 and extending into the channel 1500 limits how much the primary retainer pin 1256 can extend out of the shift drum 1252. The primary retainer pin 1256 can slide within the channel 1500 between retracted and extended positions. The primary retainer biasing member 1310 biases the primary retainer pin 1256 toward the extended position.

Similarly, the shift drum 1252 defines a channel 1510 in which the secondary retainer pin 1257 and the secondary retainer biasing member 1311 are received. More specifically, the channel 1510 is a through channel, and passes through a radial center point of the shift drum 1252. It is contemplated that the channel 1510 may not be a through channel. One end of the channel 1510 is closed by a fastener 1512. The fastener 1512 engages the secondary retainer biasing member 1311. The secondary retainer biasing member 1311 is further engaged to the secondary retainer pin 1257. The secondary retainer pin 1257 partially extends out of the channel 1510. A lip 1511 defined by the shift drum 1252, and extending into the channel 1510, limits how much the secondary retainer pin 1257 can extend out of the shift drum 1252. The secondary retainer pin 1257 can slide within the channel 1510 between retracted and extended positions. The secondary retainer biasing member 1311 biases the secondary retainer pin 1257 toward the extended position.

The shifting assembly 1250 is configured such that the primary retainer pin 1256 and the secondary retainer pin 1257 are laterally spaced from one another, and are angularly offset from one another.

Referring to FIG. 22, when the dog gear 1160 is in the primary engaged dog position, the primary retainer pin 1256 abuts the shift fork 1258, thereby preventing movement of the shift fork 1258, and thus, preventing movement of the dog gear 1160 away from the primary engaged dog position.

Referring to FIG. 23, when the dog gear 1160 is in the secondary engaged dog position, the secondary retainer pin 1257 abuts the shift fork 1258, thereby preventing movement of the shift fork 1258, and thus, preventing movement of the dog gear 1160 away from the secondary engaged dog position.

Referring back to FIG. 21, when the dog gear 1160 is in the disengaged dog position, the primary retainer pin 1256 and the secondary retainer pin 1257 are angularly offset from the shift fork 1258, and since neither of the pins 1256, 1257 abuts a lateral side of the shift fork 1258, movement of the shift fork 1258 is not restricted by the pins 1256, 1257.

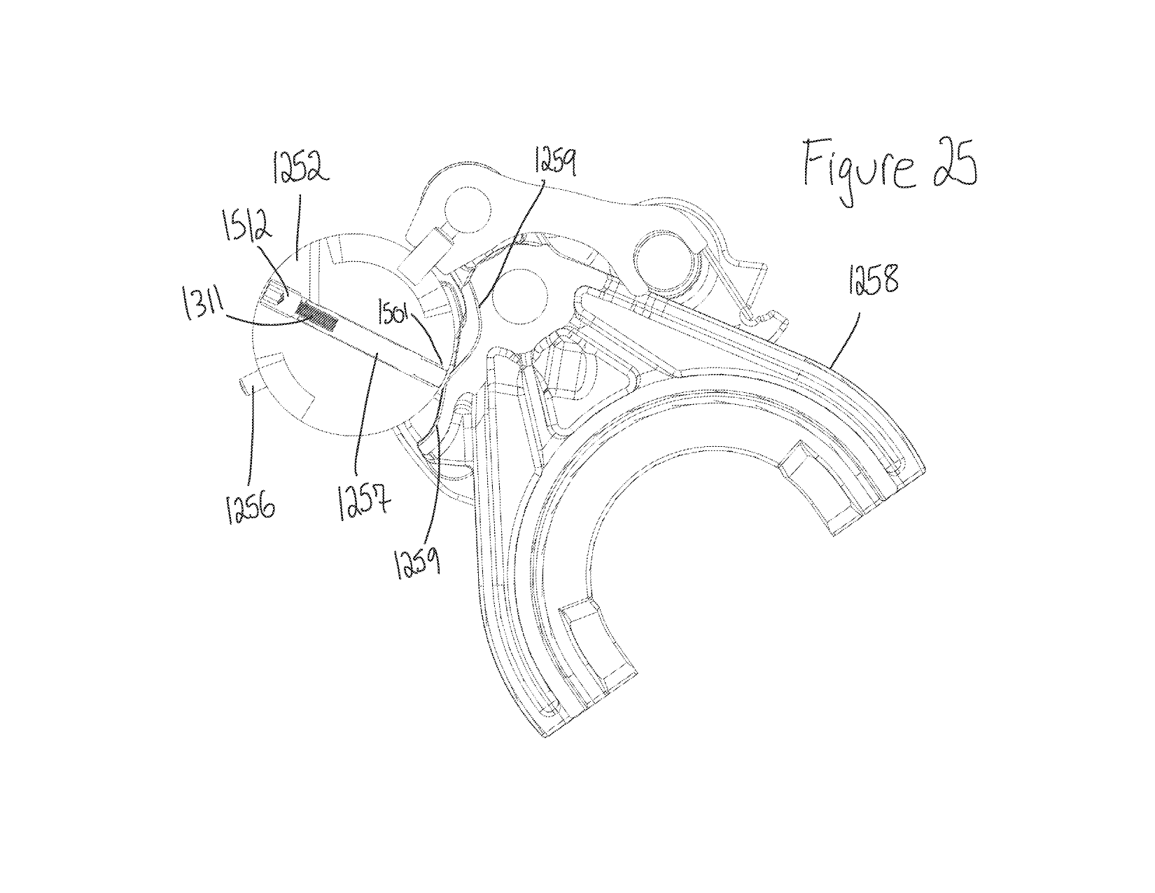

Referring to FIG. 25, as the shift fork 1258 moves laterally, the shift fork 1258 may laterally align with the primary retainer pin 1256 or the secondary retainer pin 1257. To this end, the shift fork 1258 is provided with ramped portions 1259 to guide the primary retainer pin 1256 or the secondary retainer pin 1257 toward their retracted positions, such that the shift fork 1258 does not impede rotation of the shift drum 1252 (similar to the front surface 342 abutting against the retainer 256). When the shift fork 1258 is laterally offset from the primary retainer pin 1256 or the secondary retainer pin 1257, the respective primary retainer pin 1256 or the secondary retainer pin 1257 moves back toward the extended positions, due to their respective biasing members 1310, 1311.

It is contemplated that in some embodiments, the primary retainer pin 1256 and the primary retainer biasing member 1310 could be used with the transmission 100.

Modifications and improvements to the above-described embodiments of the present technology may become apparent to those skilled in the art. The foregoing description is intended to be exemplary rather than limiting.

What is claimed is:

1. A transmission comprising:
an input shaft configured for operatively connecting to a motor;
an input gear connected to the input shaft, the input gear being drivingly engaged to the input shaft;
a shaft;
a drive gear connected to the shaft, the drive gear selectively rotating relative to the shaft, and the drive gear drivingly engaging the input gear;
a dog gear connected to the shaft, the dog gear drivingly engaging the shaft, and the dog gear selectively axially translating along the shaft between:
an engaged dog position in which the dog gear is drivingly engaged with the drive gear such that the dog gear rotates together with the drive gear; and
a disengaged dog position in which the dog gear is disengaged from the drive gear,
an output gear connected to the shaft, the output gear drivingly engaging the shaft;
a shifting assembly including:
a shift drum selectively rotating about a shift drum axis between a first drum position and a second drum position;
a retainer connected to the shift drum, the retainer selectively moving between a retracted position and an extended position;
a retainer biasing member biasing the retainer toward the extended position;
a shift fork engaging the shift drum and operatively connected to the dog gear, the shift fork selectively moving between an engaged fork position and a disengaged fork position,
with the shift fork in the engaged fork position, the shift drum is in the first drum position; and
with the shift fork in the disengaged fork position, the shift drum is in the second drum position;
a shift fork biasing member biasing the shift fork toward the engaged fork position;
the shifting assembly having:
a drive configuration in which:
the shift drum is in the first drum position;
the shift fork is in the engaged fork position, such that the dog gear is in the engaged dog position; and
the retainer is in the extended position, and prevents the shift fork from moving toward the disengaged fork position,
a neutral configuration in which:
the shift drum is in the second drum position;
the shift fork is in the disengaged fork position, such that the dog gear is in the disengaged dog position; and
the retainer permits the shift fork to move between the disengaged fork position and the engaged fork position,
in response to the shift drum rotating from the second drum position toward the first drum position, the shift fork moves from the disengaged fork position toward the engaged fork position, and the shift fork causes the dog gear to move toward the engaged dog position.

2. The transmission of claim 1, wherein in response to the shift drum rotating from the second drum position toward the first drum position, and the shift fork being in an intermediate fork position, the intermediate fork position being between the engaged fork position and the disengaged fork position, the retainer abuts the shift fork and the shift fork causes the retainer to move toward the retracted position.

3. The transmission of claim 2, wherein the shift fork has an abutting arm configured to abut against the retainer.

4. The transmission of claim 3, wherein:
with the shift fork being in the disengaged fork position, the abutting arm is spaced from the retainer;
with the shift fork being in the engaged fork position and the retainer being in the extended position, the abutting arm is configured to abut the retainer for preventing the shift fork from moving toward the disengaged fork position; and
with the shift fork being in the intermediate fork position, part of the abutting arm is configured to abut against the retainer, and cause the retainer to move toward the retracted position.

5. The transmission of claim 1, wherein:
the shift drum has a radial surface, and the shift drum defines a guiding groove on the radial surface, the guiding groove extending along at least part of a circumference of the shift drum; and
the shift fork has a guiding pin received in the guiding groove.

6. The transmission of claim 5, wherein:
the guiding groove has a first groove section and a second groove section, the second groove section being axially narrower than the first groove section, and
with the shift drum in the second drum position, the guiding pin is in the second groove section.

7. The transmission of claim 1, wherein the shift drum has a stopper stopping the retainer at the extended position.

8. The transmission of claim 7, wherein the retainer defines a recess configured to receive the stopper therein.

9. The transmission of claim 1, wherein:
the shaft is a countershaft,
the output gear is an intermediate output gear, and
the transmission further includes:
an output shaft; and
an output gear connected to the output shaft, and the output gear being driven by the intermediate output gear.

10. The transmission of claim 1, wherein the retainer is pivotally connected to the shift drum.

11. The transmission of claim 1, wherein the retainer is a lever.

12. The transmission of claim 1, wherein:
the transmission further includes:
a park gear connected to the shaft, the park gear being drivingly engaged to the shaft,
a parking lever selectively moveable between:
a parked position in which the parking lever is engaged with the park gear such that rotation of the park gear is prevented; and
a move position in which the parking lever is disengaged from the park gear, and
the shifting assembly also has a park configuration in which the parking lever is in the parked position.

13. The transmission of claim 12, wherein the park gear and the dog gear are integral.

14. The transmission of claim 12, wherein:
the shift drum is further rotatable about the shift drum axis to a third shift drum position, the second shift drum position being intermediate to the first shift drum position and the third shift drum position; and
with the shifting assembly being in the park configuration, the shift drum is in the third shift drum position.

15. The transmission of claim 12, further comprising a parking cam operatively connected to the shift drum, the parking cam being rotatable between:
a first cam position, and
a second cam position, in which the parking cam causes the parking lever to be in the parked position.

16. The transmission of claim 15, further comprising a biasing member biasing the parking cam toward the second cam position.

17. The transmission of claim 12, wherein:
the shift drum has an axial surface, and the shift drum defines a side groove on the axial surface, the side groove having a third groove section and a fourth groove section, the fourth groove section being radially wider than the third groove section; and
the parking lever has a parking pin received in the side groove,
with the parking pin being in the third groove section, the parking lever is in the move position; and
with the parking pin being in the fourth groove section, the parking lever is moveable to the park position.

18. The transmission of claim 1, further comprising a shift motor operatively connected to the shift drum for moving the shift drum between the first shift drum position and the second shift drum position.

19. A method for shifting gears comprising:
rotating a shift drum about a shift drum axis from a first shift drum position to a second shift drum position;
in response to the shift drum rotating from the first shift drum position to the second shift drum position, moving a shift fork to a disengaged fork position, and movement of the shift fork to the disengaged fork position causing a dog gear to move to a disengaged dog position;
rotating the shift drum about the shift drum axis from the second shift drum position to the first shift drum position,
in response to the shift drum rotating from the second shift drum position to the first shift drum position, moving the shift fork toward an engaged fork position, and movement of the shift fork toward the engaged fork position causing the dog gear to move toward an engaged dog position;
moving a retainer together with the shift drum; and
in response to the shift fork reaching the engaged fork position, preventing, by the retainer, the shift fork from moving back toward the disengaged fork position.

20. The method of claim 19, wherein in response to rotating the shift drum from the second drum position toward the first drum position, and the shift fork being in an intermediate fork position, the intermediate fork position being between the engaged fork position and the disengaged fork position, the retainer abuts the shift fork and the shift fork causes the retainer to move toward a retracted position.
